(19) United States
(12) Patent Application Publication
(10) Pub. No.: US 2003/0011624 A1
(43) Pub. Date: Jan. 16, 2003

(54) Deformable transformations for interventional guidance

(76) Inventor: Randy Ellis, Kingston (CA)

Correspondence Address: DOWELL & DOWELL PC, SUITE 309, 1215 JEFFERSON DAVIS HIGHWAY, ARLINGTON, VA, 22202

(21) Appl. No.: 09/903,644

(22) Filed: Jul. 13, 2001

(51) Int. Cl. G06F 17/60; G06K 9/36; G09G 5/00

(52) U.S. Cl. 345/646; 705/2; 382/276

(57) ABSTRACT

The method includes the steps of obtaining atlas data in an atlas coordinate frame from a computer-readable atlas of anatomical information, obtaining patient data in a patient coordinate frame that corresponds to obtained atlas data in an atlas coordinate frame, and morphing atlas data using a first morphing transformation between obtained patient data in a patient coordinate frame and corresponding obtained atlas data in an atlas coordinate frame. The apparatus includes a tracking system for tracking physical objects; a computer for receiving information on tracked objects, a computer program on computer readable medium for operation on the computer. The computer program includes instructions for obtaining atlas data in an atlas coordinate frame from a computer-readable atlas of anatomical information, obtaining patient data in a patient coordinate frame that corresponds to obtained atlas data in an atlas coordinate frame, and morphing atlas data using a first morphing transformation between obtained patient data in a patient coordinate frame and corresponding obtained atlas data in an atlas coordinate frame. One may build upon the summarized aspects to provide other useful methods and apparatuses for interventional guidance.

### FIELD OF THE INVENTION

The invention relates to methods and apparatuses for providing interventional guidance for interventions on patients.

### BACKGROUND OF THE INVENTION

Computers are used by physicians to improve diagnosis of medical problems, to plan therapeutic/surgical interventions, and to perform interventions on patients. In this context the patient can be a human or another organism, and the patient can be alive or dead or unborn. An intervention is any action that has a physical effect on a patient. An intervention can be performed by a human interventionalist, such as a surgeon or a radiologist, or by a non-human interventionalist, such as a robot or a radiation-therapy system.

Current methods for computer-assisted interventions are based on one of four paradigms: (1) to intraoperatively identify anatomical landmarks (e.g., the centers of the hip, knee, and ankle for total knee arthroplasty), here called the imageless paradigm; (2) to model the anatomy from a preoperative image (e.g., computed tomography or magnetic-resonance imaging), here called the preoperative-image paradigm; (3) to guide through the anatomy with intraoperative imaging (e.g., X-ray fluoroscopy or ultrasound), here called the intraoperative-image paradigm; or (4) to use both preoperative and intraoperative images, here called the multiple-image-type paradigm. The position and orientation of a geometrical entity or physical object is called the pose of the entity or object, where it is understood that the orientation of a point is arbitrary and that the orientation of a line or a plane or other special geometrical objects may be specified with only two, rather than the usual three, orientation parameters.

Current methods for performing computer-assisted interventions without using images rely on locating anatomical features of the patient during the intervention. The geometrical relationships between and among the features are used to plan and perform the intervention. The imageless paradigm can be useful in improving the performance of orthopedic surgery, such as hip replacement or knee replacement. The paradigm relies on tracking the patient, This paradigm also relies on tracking either a calibrated surgical instrument or a distinct anatomical part of the patient 401b, in which case the latter acts as an instrument, and so either the former or the latter will be variously called herein an actual instrument or a tracked actual instrument.

An example of performing a computer-assisted intervention without images uses a computer and a tracking system. A first tracking device is attached to a patient and the tracking system provides to the computer three-dimensional information of the pose of the first tracking device, this information provided in a first coordinate system that may be the coordinate system of the tracking system. A second tracking device is attached to anactual instrument. In one embodiment the pose of the second tracking device is provided to the computer in a second coordinate system that is the coordinate system of the first tracking device, and in another embodiment the pose of the tracking device is provided to the computer in the first coordinate system and the computer computes the pose of the second tracking device in the coordinate system of the first tracking device. If the second tracking device is attached to a calibrated surgical instrument then a physician identifies anatomical regions of the patient and either the tracking system, or the computer, or both, determines the pose of the guidance point on the surgical instrument in the coordinate system of the first tracking device: the coordinate system of the first tracking device acts as the coordinate system of the patient 401b. If the second tracking device is attached to a distinct anatomical part of the patient then the physician manipulates the two anatomical parts so that either the tracking system, or the computer, or both, determines the pose of an anatomical feature of interest in the coordinate system of the first tracking device: the coordinate system of the first tracking device acts as the coordinate system of the patient 401b. The points or features in the patient coordinate system are used to determine a geometrical entity or entities, such as a point of rotation or an axis, that are recognized by those skilled in the art to be of clinical relevance. This method can improve the ability of the physician to perform an intervention by providing the physician with information that relates the pose of one of the tracked actual instruments to the geometrical entity or entities.

Current methods for performing computer-assisted interventions using preoperative images rely on a registration between one or more preoperative images and the anatomy of an individual patient 401b. A registration is a rigid transformation, comprising a rotation and a translation. A registration may be calculated from direct contact with the anatomy of a patient, or by non-contact sensing of the anatomy of a patient 401b. A preoperative image of a patient is required to perform an intervention. The preoperative-image paradigm can be useful in improving the performance of many kinds of surgery, including neurosurgery, orthopedic surgery, and maxillofacial surgery.

An example of performing a computer-assisted intervention with a preoperative image or images uses a computer, into which the preoperative image or images have been stored, and a tracking system. FIG. 1 shows an apparatus that can be used for conventional guidance with a preoperative image. A first tracking device is attached to a patient and the tracking system 101 provides to the computer 104 three-dimensional information of the pose 103 of the first tracking device, this information is provided in a first coordinate system that may be the coordinate system of the tracking system. A second tracking device is attached to an actual instrument, so the pose 102 of a guidance point on the actual instrument can be provided to the computer. In one embodiment the pose of the second tracking device is provided to the computer in the coordinate system of the first tracking device, and in another embodiment the pose of the tracking device is provided to the computer in a second coordinate system that is the first coordinate system and the computer computes the pose of the second tracking device in the coordinate system of the first tracking device. A physician directly contacts surfaces of anatomical regions of the patient and the tracking system, or the computer, or both, determines the pose of the guidance point on the actual instrument in the coordinate system of the first tracking device, so that the coordinate system of the first tracking device acts as the coordinate system of the patient 401b. The surface points in the patient coordinate system act as data that are used to determine a rigid transformation between the coordinate system or systems 105 of the preoperative image or images and the coordinate system of the patient 401b. FIG. 2 shows the patient data 201, a preoperative image 202, and the result 204 of applying the registration transformation 203 to the preoperative image. The computer, or another computer, can then relate the pose of a tracked actual instrument or of another tracked actual instrument to the preoperative image or images. FIG. 3 shows a method that can be used for conventional guidance with a preoperative image, in which the registration transformation 305 from an image coordinate frame 304 to the patient coordinate frame 302 and the pose 303 of the tracked actual instrument 301 relative to the patient can be used to superimpose a drawing 308 of a virtual instrument on a slice of a preoperative image 306. This method can improve the ability of the physician to perform an intervention by providing the physician with information that relates the pose of one of the tracked actual instruments to the preoperative image or images.

Current methods for performing computer-assisted interventions using intraoperative images rely on relating the pose of a patient to the pose(s) of one or more devices that form an intraoperative image of a patient 401b. For example, tracking devices may be attached to a patient and a second tracking device is attached to an imaging device, such as an X-ray fluoroscope. Rather than performing a registration between a patient and a preoperative medical image or images, a tracking system correlates the pose of a patient and the pose of an imaging device at the time of image formation. The intraoperative images are then used to guide a physician during performance of an intervention. The intraoperative-image paradigm can be useful can be useful in improving the performance of many kinds of surgery, including neurosurgery, orthopedic surgery, and interventional radiology.

An example of performing a computer-assisted intervention with an intraoperative image or images uses a calibrated image-forming device that forms the intraoperative image or images and a computer, into which the intraoperative image or images can be stored, and a tracking system. A first tracking device is attached to a patient and the tracking system provides to the computer three-dimensional information of the pose of the first tracking device, this information is provided in a first coordinate system that may be the coordinate system of the tracking system. A second tracking device is attached to a calibrated image-forming device so that, when an image is formed, simultaneously or nearly simultaneously the pose of the calibrated image-forming device and the pose of the patient can be determined by the tracking system and provided to the computer. In one embodiment the pose of the second tracking device is provided to the computer in the coordinate system of the first tracking device, and in another embodiment the pose of the tracking device is provided to the computer in a second coordinate system that is the first coordinate system and the computer computes the pose of the second tracking device in the coordinate system of the first tracking device. A third tracking device is attached to an actual instrument, so the pose of a guidance point on the actual instrument can be provided to the computer in the coordinate system of the patient 401b. The computer, or another computer, can then relate the pose of the tracked actual instrument or of another tracked actual instrument to the intraoperative image or images. This method can improve the ability of the physician to perform an intervention by providing the physician with information that relates the pose of one of the tracked actual instruments to the intraoperative image or images.

Current methods for performing computer-assisted interventions using multiple image types rely on a registration between one or more preoperative images and the anatomy of an individual patient and also on relating the pose of a patient to the pose(s) one or more devices that form an intraoperative image of a patient 401b. One advantage of using multiple image types is that the preoperative image can be used for planning the intervention and that intraoperative images can be used to compensate for tissue changes that occur during the intervention. The multiple-image-type paradigm can be useful in improving the performance of many kinds of surgery, including neurosurgery and orthopedic surgery.

An example of performing a computer-assisted intervention with multiple image types uses a calibrated image-forming device that forms the intraoperative image or images and a computer, into which the preoperative or intraoperative images can be stored, and a tracking system. A first tracking device is attached to a patient and the tracking system provides to the computer three-dimensional information of the pose of the first tracking device, this information provided in a first coordinate system that may be the coordinate system of the tracking system. A second tracking device is attached to a calibrated image-forming device so that, when an image is formed, simultaneously or nearly simultaneously the pose of the calibrated image-forming device and the pose of the patient can be determined by the tracking system. In one embodiment the pose of the second tracking device is provided to the computer in the coordinate system of the first tracking device, and in another embodiment the pose of the tracking device is provided to the computer in a second coordinate system that is the first coordinate system and the computer computes the pose of the second tracking device in the coordinate system of the first tracking device. A third tracking device is attached to an actual instrument, so the pose of a guidance point on the actual instrument can be provided to the computer in the coordinate system of the patient 401b.

In a first embodiment a computer calculates a registration between the preoperative images and the intraoperative images, where the surfaces of image creation of the intraoperative images are calculated in a patient coordinate frame. One way that such a registration can be calculated is to use one or more digitally reconstructed radiographs (DRR's) from a preoperative image. In such a DRR for registering to a projective intraoperative image, the DRR focal point corresponds to the real focal point of the projective intraoperative imaging device and the virtual surface of creation of a digitally reconstructed radiograph corresponds to the real surface of creation of the projective intraoperative imaging device. In such a DRR for registering to a tomographic intraoperative image, the DRR focal point or DRR projective direction corresponds to a direction parallel to the normal of a point on the surface of creation of the tomographic intraoperative imaging device. By measuring the disparity between one or more intraoperative images and one or more DRR's, and by minimizing this disparity, a registration can be calculated from the coordinate frame of the patient to the coordinate frame or coordinate frames of the atlas. As for the first embodiment, the computer, or another computer, can then relate the pose of the tracked actual instrument or of another tracked actual instrument to the preoperative image or images. Further, the computer, or another computer, can then relate the pose of the tracked actual instrument or of another tracked actual instrument to the intraoperative image or images.

In a second embodiment a physician directly contacts surfaces of anatomical regions of the patient, and the tracking system or the computer, or both, determines the pose of the guidance point on the actual instrument in the coordinate system of the first tracking device, so that the coordinate system of the first tracking device acts as the coordinate system of the patient 401b. The surface points in the patient coordinate system are used to determine a rigid transformation between the coordinate system or systems of the preoperative image or images and the coordinate system of the patient 401b. The computer, or another computer, can then relate the pose of the tracked actual instrument or of another tracked actual instrument to the preoperative image or images. Further, the computer, or another computer, can then relate the pose of the tracked actual instrument or of another tracked actual instrument to the intraoperative image or images.

In either embodiment, the method of using multiple image types can improve the ability of the physician to perform an intervention by providing the physician with information that relates the pose of one of the tracked actual instruments to both the preoperative image or images and the intraoperative image or images.

Practitioners of the art know that there are methods for relating preoperative images of a patient to an atlas. For example, a deformable transformation can be calculated between an image of the patient and the atlas. It is typical for such an image of the patient to be of poorer resolution than is the atlas, so the deformable transformation can be used to improve the resolution of the image of the patient 401b. It is also possible for the atlas to be tagged with other information, such as functional information. It will be understood by practitioners of the art that a deformable transformation between the patient and the atlas can be used to improve the diagnosis of a medical condition and to improve the planning of an intervention.

Each of the four paradigms has limitations. The imageless paradigm does not provide any image information, which compromises the ability of a physician to ensure that the relevant anatomical landmarks have been correctly identified. The preoperative-image paradigm requires preoperative scans, which may be costly or logistically inconvenient. The intraoperative-image paradigm does not provide detailed preoperative planning information during performance of the procedure. The multiple-image-type paradigm also requires a preoperative scan, which may be costly or logistically inconvenient.

### SUMMARY OF THE INVENTION

The invention provides a variety of different aspects, some of which are summarized below. The invention may build upon the summarized aspects to provide other useful methods and apparatuses for interventional guidance.

In a first aspect the invention provides a method of obtaining interventional guidance for a patient. The method includes the steps of obtaining atlas data in an atlas coordinate frame from a computer-readable atlas of anatomical information, obtaining patient data in a patient coordinate frame that corresponds to obtained atlas data in an atlas coordinate frame, and morphing atlas data using a first morphing transformation between obtained patient data in a patient coordinate frame and corresponding obtained atlas data in an atlas coordinate frame.

The method may include the step of presenting morphed atlas data to an interventionalist.

The step of obtaining patient data in a patient coordinate frame that correspond to atlas data in an atlas coordinate frame may include collecting a plurality of points in a patient coordinate frame from the patient that correspond to points in an atlas coordinate frame from the atlas.

The obtained patient data may include a plurality of points from the patient anatomy in a patient coordinate frame, and the obtained atlas data may include a plurality of points from the atlas in an atlas coordinate frame.

The method may include obtaining an image of the patient including a plurality of points in an image coordinate frame that correspond to points in an atlas coordinate frame from the atlas, collecting a plurality of points in a patient coordinate frame from the patient that correspond to points in an atlas coordinate frame from the atlas, and collecting a plurality of points in a patient coordinate frame from the patient that correspond to points in an image coordinate frame from the image,

The method may include morphing the atlas to the image using a second morphing transformation between points in an image coordinate frame and corresponding points in an atlas coordinate frame, and registering the image to the patient using a registration transformation between a plurality of points in a patient coordinate frame and corresponding points in an image coordinate frame, and wherein the step of morphing the atlas to the patient using a morphing transformation between points in a patient coordinate frame and corresponding points in an atlas coordinate frame may include the step of morphing the atlas to the patient using a third morphing transformation comprising the second morphing transformation and the registration transformation.

The method may include the steps of morphing the atlas to the image using a second morphing transformation between an image coordinate frame and a corresponding atlas coordinate frame, and registering the image to the patient using a registration transformation between a plurality of patient coordinates and corresponding image coordinates.

The method may include the steps of morphing the atlas to the image using a second morphing transformation between points in an image coordinate frame and corresponding points in an atlas coordinate frame, and morphing the atlas to the patient using a third morphing transformation between points in a patient coordinate frame and corresponding points in an atlas coordinate frame, and the step of morphing the atlas to the patient using a morphing transformation between points in a patient coordinate frame and corresponding points in an atlas coordinate frame may include the step of morphing the image to the patient using a fourth morphing transformation comprising the second morphing transformation and the third morphing transformation.

The method may include the steps of obtaining a relative pose of an actual instrument relative to the patient, tracking the relative pose of the actual instrument; and updating the relative pose of a virtual instrument to be the same as the relative pose of the actual instrument.

The method may include the step of presenting the updated virtual instrument with the morphed atlas data to an interventionalist.

The step of obtaining a patient data in a patient coordinate frame that correspond to atlas data in an atlas coordinate frame may include the step of collecting patient data in a patient coordinate frame from the patient that corresponds to atlas data in an atlas coordinate frame from the atlas.

The method may include the steps of obtaining an image of the patient including image data in an image coordinate frame that correspond to atlas data in an atlas coordinate frame from the atlas.

The image may be a preoperative image. The image may be an intraoperative image.

The method may include the steps of morphing atlas data using a second morphing transformation between obtained image data in an image coordinate frame and corresponding obtained atlas data in an atlas coordinate frame, and registering image data to patient data using a registration transformation between obtained patient data in a patient coordinate frame and corresponding obtained image data, and the step of morphing the atlas data using a morphing transformation between patient data in a patient coordinate frame and corresponding atlas data in an atlas coordinate frame may include the step of morphing atlas data using a third morphing transformation comprising the second morphing transformation and the registration transformation.

The method may include the steps of morphing atlas data using a second morphing transformation between image data in an image coordinate frame and corresponding atlas data in an atlas coordinate frame, and registering image data and morphed atlas data from the second morphing transformation using a registration transformation between obtained patient data and corresponding obtained image data.

The method may include the steps of morphing atlas data using a second morphing transformation between image data in an image coordinate frame and corresponding atlas data in an atlas coordinate frame, and morphing image data to the patient using a third morphing transformation comprising the first morphing transformation and the second morphing transformation.

The method may include the steps of registering image data using a registration transformation between obtained patient data and corresponding obtained image data, and morphing atlas data using a second morphing transformation comprising the first morphing transformation and the registration transformation.

The method may include the step of registering image data using a registration transformation between obtained patient data and corresponding obtained image data.

The method may include the step of morphing atlas data using a second morphing transformation between image data in an image coordinate frame and corresponding atlas data in an atlas coordinate frame.

The method may include the steps of obtaining a relative pose of an image from an image coordinate frame to a patient coordinate frame, and morphing atlas data using a morphing transformation between obtained atlas data and corresponding obtained image data, and

the step of morphing the atlas data using a morphing transformation between patient data in a patient coordinate frame and corresponding atlas data in an atlas coordinate frame may include the steps of morphing atlas data using a morphing transformation comprising the first morphing transformation and the relative pose.

The method may include the steps of obtaining a relative pose of an image from an image coordinate frame to a patient coordinate frame, and morphing atlas data using a morphing transformation between obtained atlas data and corresponding obtained image data.

The method may include the steps of morphing atlas data using a second morphing transformation between obtained atlas data and corresponding obtained image data, and morphing atlas data using a third morphing transformation comprising the first morphing transformation and the second morphing transformation.

The method may include the steps of obtaining a relative pose of an image from an image coordinate frame to a patient coordinate frame, and morphing atlas data using a second morphing transformation comprising the first morphing transformation and the relative pose of the image coordinate frame to the patient coordinate frame.

The method may include the steps of obtaining a relative pose of an image from an image coordinate frame to a patient coordinate frame.

The method may include the steps of morphing atlas data using a morphing transformation between obtained atlas data and corresponding obtained image data.

The method may include the steps of obtaining a preoperative image of the patient including image data in an image coordinate frame that correspond to atlas data in an atlas coordinate frame from the atlas, obtaining an intraoperative image of the patient including image data in an image coordinate frame that correspond to atlas data in an atlas coordinate frame from the atlas, obtaining a relative pose of an intraoperative image from an intraoperative image coordinate frame to a patient coordinate frame, registering preoperative image data using a registration transformation between obtained patient data and corresponding obtained preoperative image data, morphing atlas data using a second morphing transformation between obtained atlas data and corresponding obtained preoperative image data, morphing atlas data using a four morphing transformation comprising the registration transformation, the relative pose, and the second morphing transformation, morphing morphed atlas data morphed by the fourth morphing transformation and intraoperative image data using a fifth morphing transformation comprising the registration transformation and the relative pose, and

the step of morphing the atlas data using a first morphing transformation between patient data in a patient coordinate frame and corresponding atlas data in an atlas coordinate frame may include the step of morphing atlas data using a third morphing transformation comprising the registration transformation and the second morphing transformation.

In a second aspect the invention provides an apparatus for obtaining interventional guidance for a patient. The apparatus includes means for obtaining atlas data in an atlas coordinate frame from a computer-readable atlas of anatomical information; means for obtaining patient data in a patient coordinate frame that corresponds to obtained atlas data in an atlas coordinate frame, and means for morphing atlas data using a first morphing transformation between obtained patient data in a patient coordinate frame and corresponding obtained atlas data in an atlas coordinate frame.

The apparatus may include means for presenting the morphed atlas data to an interventionalist.

The apparatus may include means for obtaining a relative pose of an actual instrument relative to the patient, means for tracking the relative pose of the actual instrument; and means for updating the relative pose of a virtual instrument to be the same as the relative pose of the actual instrument. The apparatus may include means for presenting the updated virtual instrument with the morphed atlas data to an interventionalist.

In a third aspect the invention provides an apparatus for obtaining interventional guidance for a patient. The apparatus includes a tracking system for tracking physical objects; a computer for receiving information on tracked objects, a computer program on computer readable medium for operation on the computer. The computer program includes instructions for obtaining atlas data in an atlas coordinate frame from a computer-readable atlas of anatomical information, obtaining patient data in a patient coordinate frame that corresponds to obtained atlas data in an atlas coordinate frame, and morphing atlas data using a first morphing transformation between obtained patient data in a patient coordinate frame and corresponding obtained atlas data in an atlas coordinate frame.

In a fifth aspect the invention provides the computer program of the fourth aspect.

### BRIEF DESCRIPTION OF THE DRAWINGS

For a better understanding of the present invention and to show more were clearly how it may be carried into effect, reference will now be made, by way of example, to the accompanying drawings that show the preferred embodiment of the present invention and in which:

FIG. 1 is a diagrammatic sketch of an apparatus that can be used for conventional guidance with a preoperative image,

FIG. 2 is a diagrammatic sketch of patient data, a preoperative image, and a result of applying a registration transformation to the preoperative image using the apparatus of FIG. 1,

FIG. 3 is a diagrammatic sketch of a method that can be used for conventional guidance with a preoperative image using the apparatus of FIG. 1,

FIG. 4 is a diagrammatic sketch of an apparatus according to a preferred embodiment of the present invention that can be used for morphed guidance without images,

FIG. 5 is a diagrammatic sketch of patient data, an atlas image, and a result of applying a morph transformation to the atlas image using the apparatus of FIG. 4,

FIG. 6 is a diagrammatic sketch of a method that can be used for morphed guidance with an atlas image using the apparatus of FIG. 4,

FIG. 7 is a diagrammatic sketch of a method that can be used for morphed guidance with preoperative images using the apparatus of FIG. 4,

FIG. 8 is a diagrammatic sketch of how a morph transformation and tracking of an actual instrument pose can be used to morph an atlas image and superimpose a drawing of a virtual instrument on a morphed slice of the atlas image, in combination or separate from use of a registration transformation and tracking of the actual instrument pose can be used to show a preoperative image and superimpose a drawing of a virtual instrument on a morphed slice of the preoperative image,

FIG. 9 is a diagrammatic sketch of a set of coordinate transformations of the preferred embodiment for use with preoperative images,

FIG. 10 is a diagrammatic sketch of a set of coordinate transformations of an alternate embodiment for use with preoperative images,

FIG. 11 is a diagrammatic sketch of a set of coordinate transformations of a second alternate embodiment for use with preoperative images,

FIG. 12 is a diagrammatic sketch of a set of coordinate transformations of a third alternative embodiment for use with preoperative images,

FIG. 13 is a diagrammatic sketch of a set of coordinate transformations of a fourth alternate embodiment for use with preoperative images,

FIG. 14 is a diagrammatic sketch of a set of coordinate transformations of a fifth alternate embodiment for use with preoperative images intraoperative

FIG. 16 is a diagrammatic sketch of a set of coordinate transformations of an alternate embodiment for use with intraoperative images,

FIG. 17 is a diagrammatic sketch of a set of coordinate transformations of a second alternate embodiment for use with intraoperative images,

FIG. 18 is a diagrammatic sketch of a set of coordinate transformations of a third alternative embodiment for use with intraoperative images,

FIG. 19 is a diagrammatic sketch of a set of coordinate transformations of a fourth alternate embodiment for use with intraoperative images,

FIG. 20 is a diagrammatic sketch of a set of coordinate transformations of a fifth alternate embodiment for use with intraoperative images,

FIG. 21 is a diagrammatic sketch of a set of coordinate transformations of the preferred embodiment for use with multiple image types.

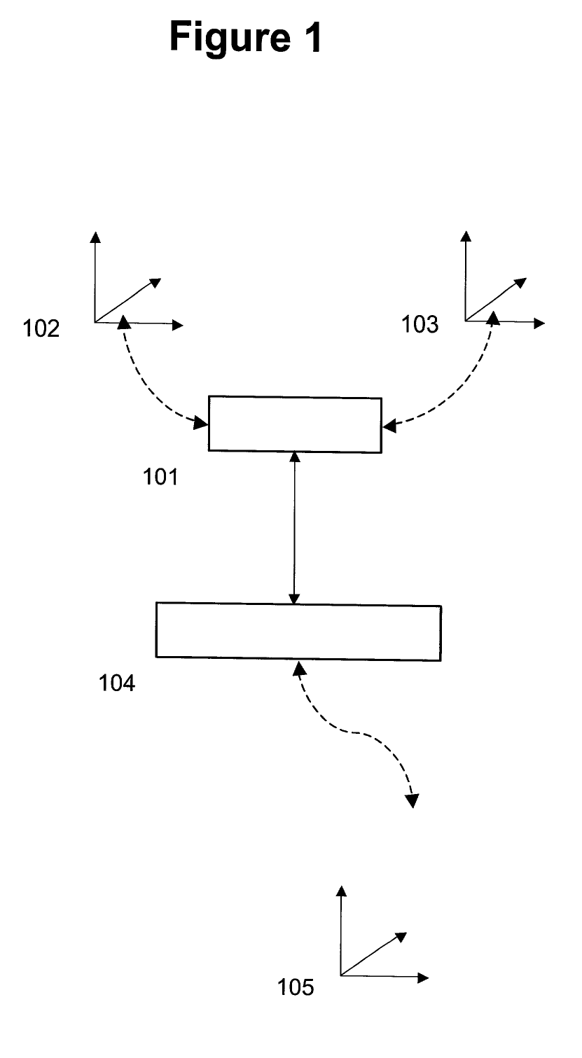

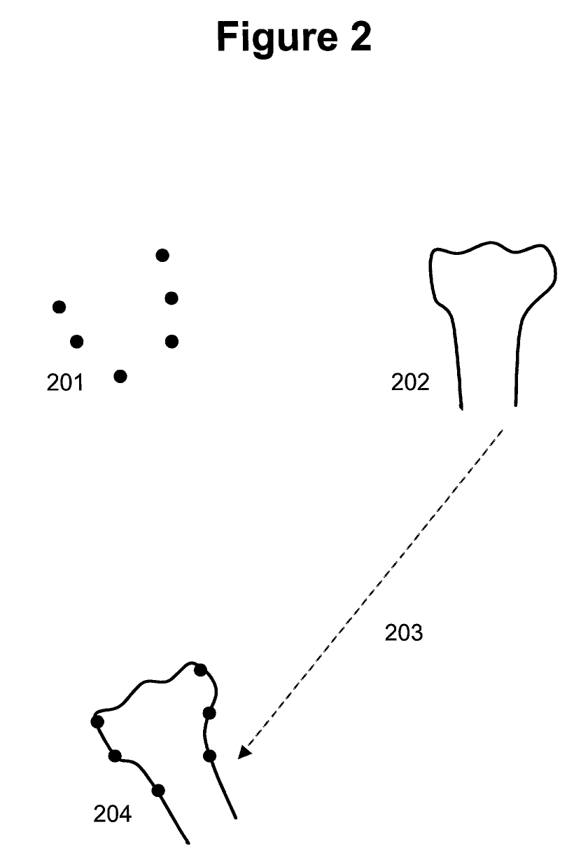

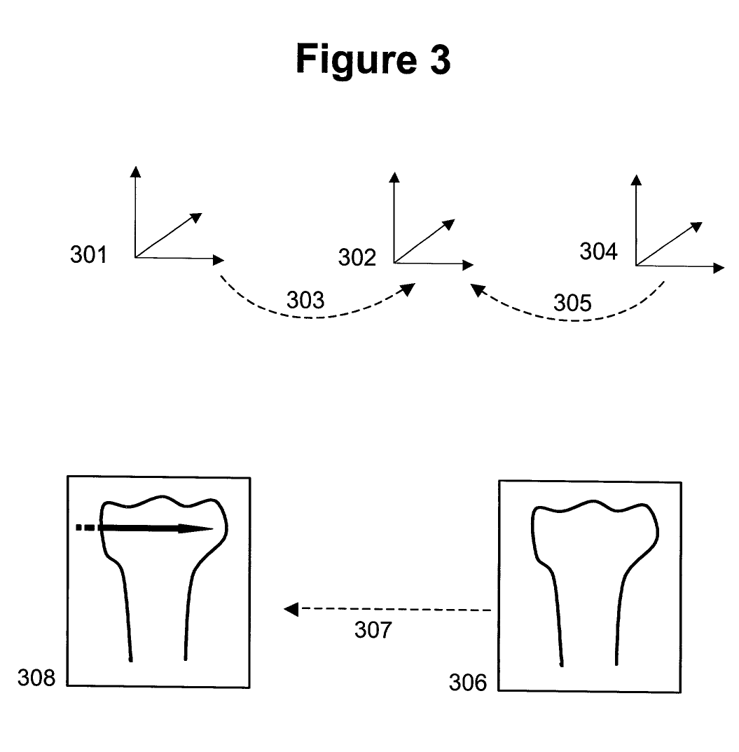

### DETAILED DESCRIPTION OF THE INVENTION

The methods and apparatuses described herein can improve the performance of interventions by taking advantage of transformations between the anatomy of an individual patient and an atlas. They can be useful in improving any of the four paradigms of intervention. The methods can use a nonrigid, or deformable, transformation between the atlas and either the anatomy of an individual patient or one or more images of the anatomy of an individual patient, or a combination thereof. This can provide a physician with information otherwise unavailable.

An atlas is defined here, for the purposes of this description, as a computer-readable description of anatomical information. The anatomical information may include images and geometrical entities and annotations and other information. An image may be: a one-dimensional image, such as an ultrasound echo or an X-ray line; a two-dimensional image, such as a plain X-ray image or an ultrasound image or a digitally reconstructed radiograph (DRR) formed from a three-dimensional image; a three-dimensional image, such as a computed tomography scan or a magnetic resonance image or a three-dimensional ultrasound image or a time sequence of two-dimensional images; or a four-dimensional image, such as a time sequence of three-dimensional images; or any other information that may be interpreted as an image. Geometrical entities may be: points; curves; surfaces; volumes; sets of geometrical entities; or any other information that may be interpreted as a geometrical entity. An annotation may be: material properties; physiological properties; radiological absorptiometric properties. An atlas, therefore, is a form of spatial database that can be queried and updated.

An atlas can be derived from one or more data sources. An atlas can be a specific atlas, which is an atlas derived from data collected prior to the operative procedure from the patient, or can be a generic atlas, which is an atlas derived from data from sources other than the patient, or can be a combined atlas, which is an atlas derived from data collected prior to the operative procedure from the patient combined with data from sources other than the patient 401b.

Certain technical terms are defined here for the purposes of this description. An object is a non-empty set of points. Examples of an object are a point, a line segment, a curve, a surface, and a set comprising one or more objects.

A transformation is a mathematical mapping of a point or an object in a first coordinate frame C₁ to a point or object in a second coordinate frame C₂. A transformation of a point can be represented as y=T(x) where x is a point in C₁ and y is the point in C₂ to which x is transformed. A transformation of every point in a first coordinate frame to one or more points in a second coordinate frame is a transformation from the first coordinate frame to the second coordinate frame. A transformation can be continuous or can be discontinuous. An invertible transformation is a transformation of a point in a first coordinate frame C₁ to a point in a second coordinate frame C₁, represented as y=T(x), such that there exists an inverse transformation x=T⁻¹(y).

A rigid transformation is a transformation that is a rotation or a translation or both a rotation and a translation. If R is a rotation matrix that rotates a vector x about the origin of C₁, and t is a translation vector, then y=T(x)=R*x+t is a rigid transformation of x in C₁ to y in C₂.

The pose P of an object that is known in a first coordinate frame C₁ in a second coordinate frame C₂ is the rotation R and translation t that transforms a vector in the first coordinate frame C₁ to a vector in the second coordinate frame C₂ of the object, so the pose has a corresponding rigid transformation and can be represented as P={R,t}. The inverse pose of a pose P is the inverse of the corresponding rigid transformation, so the inverse of pose P is inverse pose

P⁻¹={R⁻¹,−(R⁻¹)*t}.

If the pose of a first object with a first coordinate frame is expressed as a first pose with respect to a second coordinate frame as P₁={R₁,t₁}, and the pose of a second object with a third coordinate frame is expressed as a second pose with respect to the second coordinate frame as P₁={R₂,t₂}, then the relative pose of the second object with respect to the coordinate frame of the first object can be expressed by composing the inverse pose of the first pose with the second pose to find the relative pose

P₍₁₎₂={R₂R₁⁻¹, t₂−(R₁⁻¹)*t₁}

A deformable transformation is a transformation that is not a rigid transformation. As a person skilled in the art will know, there are many different kinds of deformable transformations, any one of which could be suitable for use in interventional guidance as described herein. Tools for the calculation of deformable transformations are readily available or may be written by those skilled in the art based on available knowledge. An example of a deformable transformation is a nonrigid affine transformation; if A is a non-orthogonal 3×3 matrix, and t is a translation vector, then y=T(x)=A*x+t is a non-rigid affine transformation of x in C₁ to y in C₂. An invertible deformable transformation is a deformable transformation from a first coordinate frame to a second coordinate frame that can be inverted to find a deformable transformation from the coordinate frame to the first coordinate frame. The inverse of an invertible deformable transformation is an invertible deformable transformation. An example of an invertible deformable transformation is a nonrigid affine transformation in which the matrix A is nonsingular.

A parameterized transformation is a transformation in which mathematical entities called parameters take specific values; a parameter is a mathematical entity in the transformation other than the point in the first coordinate frame that is transformed to a point in a second coordinate frame so, for example, in the above definition of a rigid transformation both R and t are parameters of the rigid transformation. A parameter can vary continuously, in which case there are an infinite number of transformations specified by the parameter. A parameter can vary discretely, in which case there is a finite number of transformations specified by the parameter.

A morph is either an invertible deformable parameterized transformation or the result of applying an invertible deformable parameterized transformation to a set of points in a first coordinate frame that maps to another set of points, whether in the same coordinate frame or in a second coordinate frame. Whether the term refers to the transformation itself, or to its application to a set of points, is understood from the context of usage by a practitioner of the art. In any embodiment the inverse of the deformable parameterized transformation may be found analytically or numerically or by any other means of inverting a transformation.

The methods and apparatuses described herein use a morph or morphs for the purpose of providing computer-assisted intervention guidance. The methods and apparatuses are applicable to all four of the current paradigms for computer-assisted intervention, each of which will be described. The methods and apparatuses use morphing to establish a correspondence between an atlas and a patient, which is useful because information related to a geometric entity in the atlas can be related to the location of the morphed geometric entity in a patient coordinate frame and, because of the invertibility of the morphing transformation, vice versa.

A. Morphing Method for Use in Guidance Without Images

The use of morphing extends the imageless paradigm by providing atlas information to the physician using the system. The atlas information is provided by morphing an atlas to the patient for the purpose of intraoperative guidance. The morphing transformation can be calculated using data collected from the patient's anatomical surfaces and the atlas, or using data inferred from the patient's anatomy, or both forms of data, and data from the atlas.

Morphing for guidance without images of a patient can be explained by way of an example of how knee surgery might be performed. Suppose that an atlas of the human left knee has been developed from a detailed scan of a volunteer subject by computed tomography imaging, with annotated information in the atlas provided by a practitioner skilled in the art of interpreting medical images. The annotations could include surface models of the bones, the mechanical center of the distal femur, the mechanical center of the femoral head, the mechanical axis that joins the centers, the transepicondylar axis, the insertion sites of the cruciate ligaments, and numerous other points and vectors and objects that describe clinically relevant features of the human left knee. During a surgical intervention, a physician could determine a plurality of points on the surface of a patient's left femur, the points measured in a patient-based coordinate frame. A morph transformation can then be calculated between the surface models of the atlas and the corresponding points in a patient coordinate frame, such that a disparity function of the patient points and the atlas points is minimized. An example of such a morph transformation is an affine transformation, and an example of such a disparity function is a least-squares measure between the patient points and the atlas points. Using the morph transformation, a point in an atlas coordinate frame can be morphed into a patient coordinate frame.

The morphed point can be used in many ways, such as to determine the distance of the morphed point from one of the annotated axes, which provides to a physician an estimate of the location of an axis in a patient where the axis might be difficult to estimate directly from the patient 401b. The atlas acts in the place of the preoperative image and the morphing transformation acts in the place of the registration transformation. The morphed transformation can be used to determine the relationship of points from the atlas in the patient coordinate frame, which points include points other than the collected points.

In the preferred embodiment for providing computer-assisted interventional guidance without images of a patient, a computer program communicates with a tracking system and can obtain an atlas.

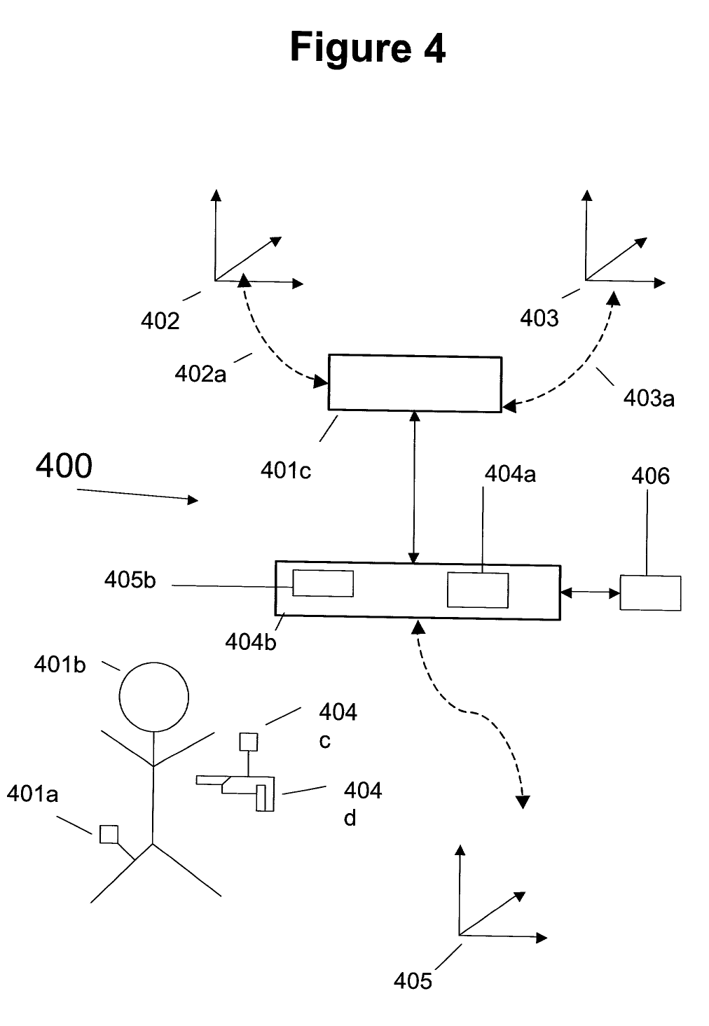

Referring to FIG. 4, an apparatus 400 that can be used for morphed guidance without images is shown. A first tracked device 401a with coordinate frame 403 is attached to a patient 401b and a tracking system 401c provides to a computer program 404a in computer 404b the pose 403a of the first tracked device 401a. In the preferred embodiment pose 403a is in the coordinate frame 403 of the first tracked device 401a. In an alternative embodiment this pose is provided in a second coordinate frame. A second tracked device 404c is attached to an actual instrument 404d. In the preferred embodiment the pose 402a of the second tracked device 404c with coordinate frame 402 is provided to the computer program 404a in coordinate frame 403 of the first tracked device 401a. In an alternative embodiment the pose 402a of the tracked device 401 a is provided to the computer program 404a in the second coordinate frame and the computer program 404a computes the relative pose 402a of the second tracked device 404c with respect to the coordinate frame 403 of the first tracked device 401a. Computer program 404a, or another computer program in computer 404b, presents results of the computations to an interventionalist by means of presentation means 406. For a human interventionalist, suitable presentations on means 406 could include graphical displays of morphed image data with guidance information superimposed, visible or audible alarms, numerical information, or haptic feedback to a limb of the human. For a non-human interventionalist, such as a robot or automatically controlled therapy device, means 406 could be a means of communication such as electrical cable, optical cable, wireless connection, or communication within computer 404b to another computer program.

As a physician physically contacts the surfaces of anatomical regions of the patient 401b and the tracking system, or the computer program 404a using the output of the tracking system 401c, or both, can determine the pose of the point on the actual instrument 404d in the coordinate frame of the first tracked device 401a, so that the coordinate frame of the first tracked device 401a acts as the coordinate frame 403 of the patient 401b. These points can be stored by the computer program 404a as data points. The data in the patient coordinate frame 403 can then be used to determine a morph transformation from a coordinate frame 405a of atlas 405b to the coordinate frame 403 of the patient 401b.

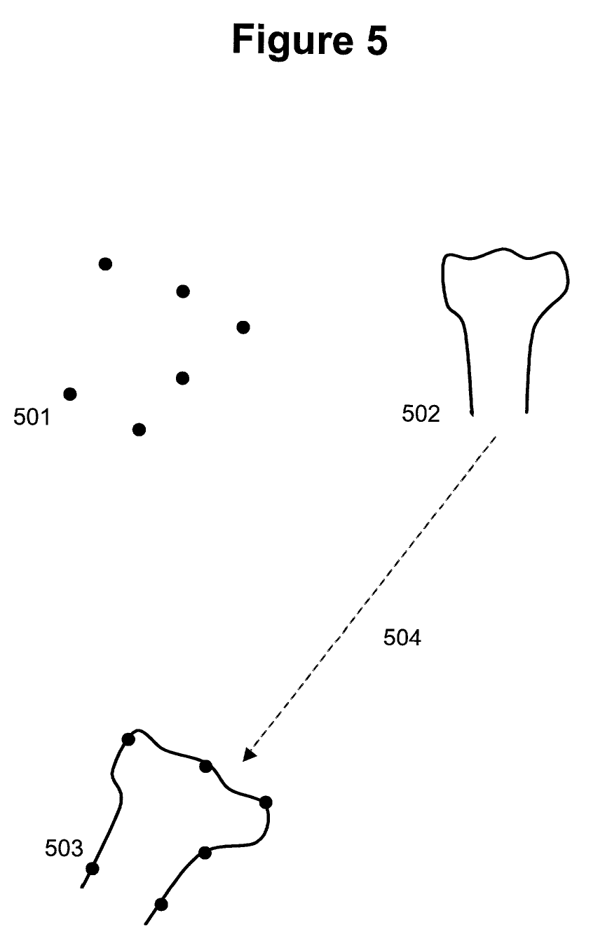

Referring to FIG. 5, the patient 401b data 501, an atlas image 502, and a result 503 of applying a morph transformation 504 to the atlas image 502 are shown. An example of a morph transformation is a nonrigid affine transformation of points from a surface model in an atlas 405b to the data points in a patient 401b coordinate frame.

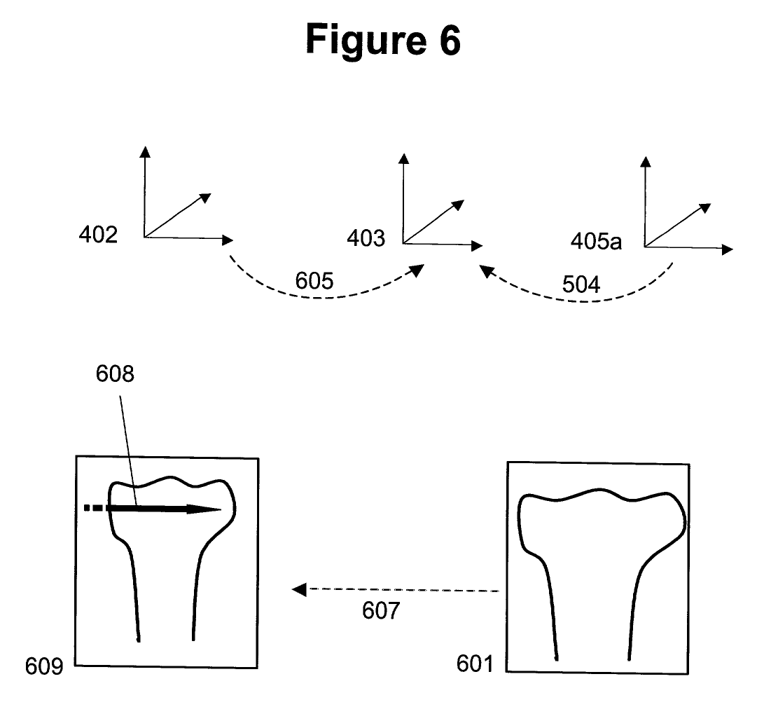

Referring to FIG. 6, a method is shown that can be used for morphed guidance with an atlas image, in which a morph transformation 504 from atlas coordinate frame 405a to patient coordinate frame 403 and pose 605 of the tracked actual instrument 404d from the actual instrument coordinate frame 402 relative to the patient 401b can be used to superimpose an image, as illustrated at 607, of a virtual instrument 608 on a morphed slice of an atlas image 609.

The computer program 404a, or another computer program, can subsequently relate the location of the tracked actual instrument 404d or of another tracked actual instrument to the atlas 405b. In the preferred embodiment, the computer program 404a morphs images and other atlas data to the coordinate frame 403 of the patient 401b, and displays these images and data to the physician with a computer representation of the tracked actual instrument 404d superimposed upon these images and data. By this method the physician can use the images and data for guidance during an intervention using a tracked actual instrument 404d within the patient 401b, without the cost and inconvenience of acquiring a three-dimensional medical image of the patient 401b. In an alternative embodiment, the computer program 404a is programmed to morph the coordinate frame 403 of the patient 401b to the coordinate frame or frames 405a of the atlas 405b, and displays atlas images and data to the physician with a computer representation of the deformed tracked actual instrument 404d superimposed upon these images and data.

Other data determined in the coordinate frame 403 of the patient 401b can be used to morph points in an atlas 405b to points in a patient 401b. Especially useful data are related to distinctive points and axes. For example, in the lower limb, some useful points are the center of the femoral head and the center of the distal femur and the center of the proximal femur and the center of the ankle; some useful axes are the femoral mechanical axis and the femoral anatomical axis and the femoral transepicondylar axis and the tibial mechanical axis and the tibial anatomical axis. These points and axes can be determined by various means, including direct contact with a tracked actual instrument 404d and indirect inference by manipulation. For example, the point that is the center of the femoral head can be determined by attaching a tracking device to the femur, then manipulating the femur with respect to the pelvis, then determining the center of rotation of the femur by minimizing a disparity function. The methods and apparatuses described herein can include the use of data determined in the coordinate frame 403 of the patient 401b to calculate one or more invertible deformable parameterized transformations from the coordinate frame or frames of an atlas 405b to the coordinate frame 403 of the patient 401b and the use of morphing for the purpose of guidance within the patient 401b.

A morphing transformation can be used to provide atlas data to an interventionalist. In the example of how knee surgery might be performed, the computer program 404a could provide to a surgeon the locations of key anatomical structures. As the surgeon moves a tracked actual instrument 404d, the computer program 404a can determine the relative pose 605 of the actual instrument 404d in the patient coordinate frame 403. Using the inverse of the morph 504 from the atlas 405b to the patient 401b, which is a morph from the patient 401b to the atlas 405b, the computer program 404a can determine the corresponding relative pose of the tracked actual instrument 404d in an atlas coordinate frame. If the atlas includes three-dimensional images, the computer program 404a can then extract two-dimensional slices in the region of the morphed pose of the tracked actual instrument 404d. These images can be presented to the surgeon, along with a morphed drawing of the tracked actual instrument 404d, but the morphed drawing of the tracked actual instrument 404d would be deformed and may lead to poor performance of the intervention. In the preferred embodiment the two-dimensional atlas images would be morphed to the patient coordinate frame 403, so that the morphed images 609 could be presented to the surgeon along with a drawing 608 of the tracked actual instrument 404d. If the atlas included data such as the pose of an anatomical point or other geometrical object, guidance information such as the distance from the tracked actual instrument 404d to the morphed pose of the anatomical point or other geometrical object could be presented to the surgeon as numerical or graphical information. If the interventionalist is a robot, the numerical information could be used to control servomotors and guide the robot in the task of performing the intervention.

B. Morphing for Use in Guidance with Preoperative Images

The use of morphing extends the preoperative-image paradigm by providing atlas 405b information to the physician using the system. The atlas 405b information is provided by morphing an atlas 405b to the patient 401b, or to a preoperative image, or to both, for the purpose of intraoperative guidance. The morphing transformation from the atlas 405b to the patient 401b can be calculated using data collected from the patient's anatomical surfaces, or data inferred from the patient's anatomy, or both forms of data, and data from the atlas 405b. The morphing transformation from the atlas 405b to a preoperative image can be calculated using data derived from the preoperative image and data from the atlas 405b. The use of preoperative images in conjunction with the atlas 405b can provide a better morph of the atlas 405b to the patient 401b.

Morphing for guidance using a preoperative image or images of a patient 401b can be explained by way of an example of how knee surgery might be performed. Suppose that an atlas 405b of the human left knee has been developed by merging several detailed scans of volunteer subjects by both computed tomography imaging and magnetic resonance imaging, with annotated information in the atlas 405b provided by a practitioner skilled in the art of interpreting medical images. The annotations could include surface models of the bones, the mechanical center of the distal femur, the mechanical center of the femoral head, the mechanical axis that joins the centers, the transepicondylar axis, the insertion sites of the cruciate and collateral ligaments, the neutral lengths of the ligaments, and numerous other points and vectors and objects that describe clinically relevant features of the human left knee. Prior to surgery a preoperative CT image of the patient's right knee could be acquired by CT scanning. The atlas images of the left knee could be morphed to the preoperative image of the patient's right knee by many means, such as point-based methods that minimize a least-squares disparity function, volumetric methods that maximize mutual information, or any other methods of determining a morphing transformation. The morph would need to include reflection about a plane to morph a left knee to a right knee, an example of such a plane being the sagittal plane.

During a surgical intervention, a physician could determine a plurality of points on the surface of a patient's right femur, the points measured in a patient-based coordinate frame 403. A registration transformation can then be calculated between the preoperative image and the points in a patient 401b coordinate frame, such that a disparity function of the points and the surface models is minimized. The morph transformation from an atlas coordinate frame to the preoperative image can then be composed with the registration transformation to provide a morph transformation from an atlas coordinate frame to a patient 401b coordinate frame. Using the morph transformation, a point in an atlas coordinate frame can be morphed into a patient 401b coordinate frame. The morphed point can be used in many ways, such as to determine the distance of the morphed point from one of the annotated axes, which provides to a physician an estimate of the location of an axis in a patient 401b where the axis might be difficult to estimate directly from the patient 401b. A computer program can then provide to the physician images derived from the preoperative image, and images and annotations derived from the atlas 405b, to improve the physician's ability to plan and perform the surgical procedure.

In a preferred embodiment for providing interventional guidance with preoperative images of a patient, a computer program communicates with a tracking system and can access one or more preoperative images and an atlas 405b. The preferred embodiment utilizes a configuration similar to that previously described for FIG. 4; namely, a first tracked device 401a with coordinate frame 403 is attached to a patient 401b and a tracking system 401c provides to a computer program 404a in computer 404b the pose 403a of the first tracked device 401a. In the preferred embodiment pose 403a is in the coordinate frame 403 of the first tracked device 401a. In an alternative embodiment this pose is provided in a second coordinate frame. A second tracked device 404c is attached to an actual instrument. In the preferred embodiment the pose 402a of the second tracked device 404c with coordinate frame 402 is provided to the computer program 404a in coordinate frame 403 of the first tracked device 401a. In an alternative embodiment the pose 402a of the tracked device 401a is provided to the computer program 404a in the second coordinate frame and the computer program 404a computes the relative pose 402a of the second tracked device 404c with respect to the coordinate frame 403 of the first tracked device 401a.

As a physician directly contacts surfaces of anatomical regions of the patient 401b and the tracking system, or the computer program 404a, or both, can determine the pose of the guidance point on the actual instrument 404d in the coordinate frame of the first tracked device 401a, so that the coordinate frame of the first tracked device 401a acts as the coordinate frame 403 of the patient 401b.

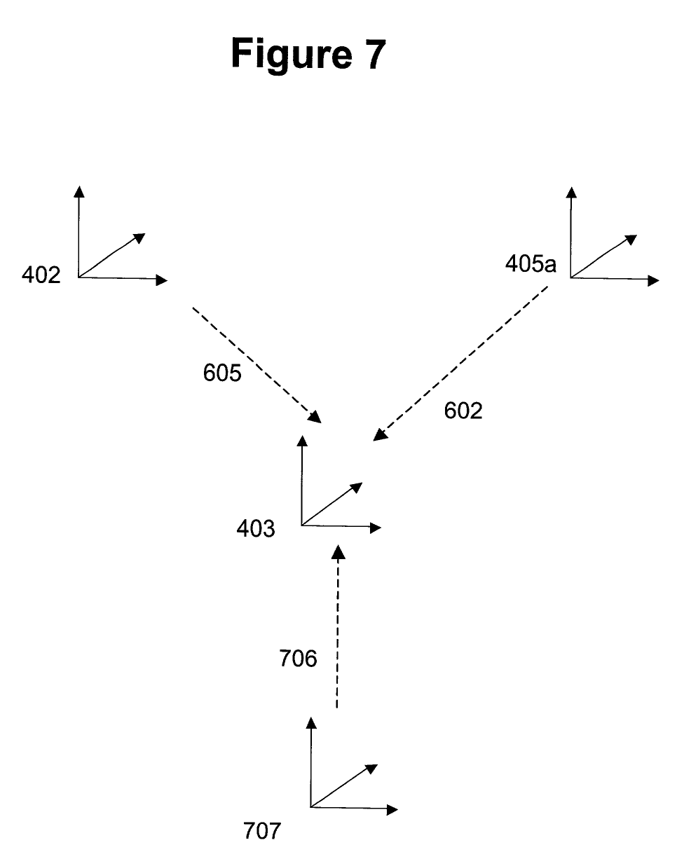

Referring to FIG. 7, a method, additionally embodied in the computer program 404a, is shown that can be used for morphed guidance with an atlas image, in which the morph transformation 504 from the atlas coordinate frame 405a to the patient coordinate frame 403 and pose 605 of the tracked actual instrument 404d from the coordinate frame 402 relative to the patient coordinate frame 403 can be combined with a morph or registration transformation 706 from a coordinate frame 707 of a preoperative image.

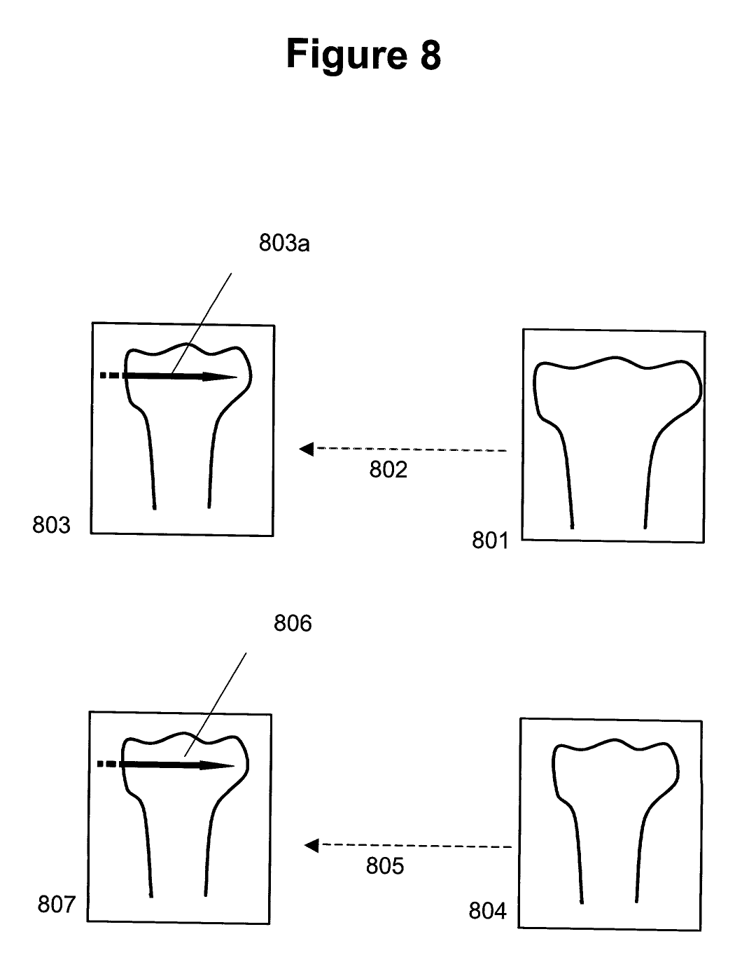

Referring to FIG. 8, a morph transformation and tracking 802 of the actual instrument 404d pose 402 can be used to morph an atlas image 801 and superimpose an image of a virtual instrument 803a on a morphed slice of the atlas image 803, in combination or separate from use of a registration transformation and tracking 805 of the actual instrument 404d pose 402 can be used to show a preoperative image 804 and to superimpose an image of a virtual instrument 806 on a morphed slice of the preoperative image 806.

In the preferred embodiment of the computer program 404a one or more morph transformations are calculated from the coordinate frame or frames 405a of the atlas 405b to the coordinate frame or frames of the preoperative image or images. A parameterization of a rigid transformation from the coordinate frame of a preoperative image to the coordinate frame 403 of the patient 401b is formulated. The parameters of the rigid transformation are calculated so as to minimize a disparity function between the transformed data in the preoperative image and corresponding data in the patient coordinate frame. The resulting registration can be mathematically and numerically composed with a morph from an atlas coordinate frame to a preoperative-image coordinate frame and thus provide a morph from an atlas coordinate frame to the patient coordinate frame.

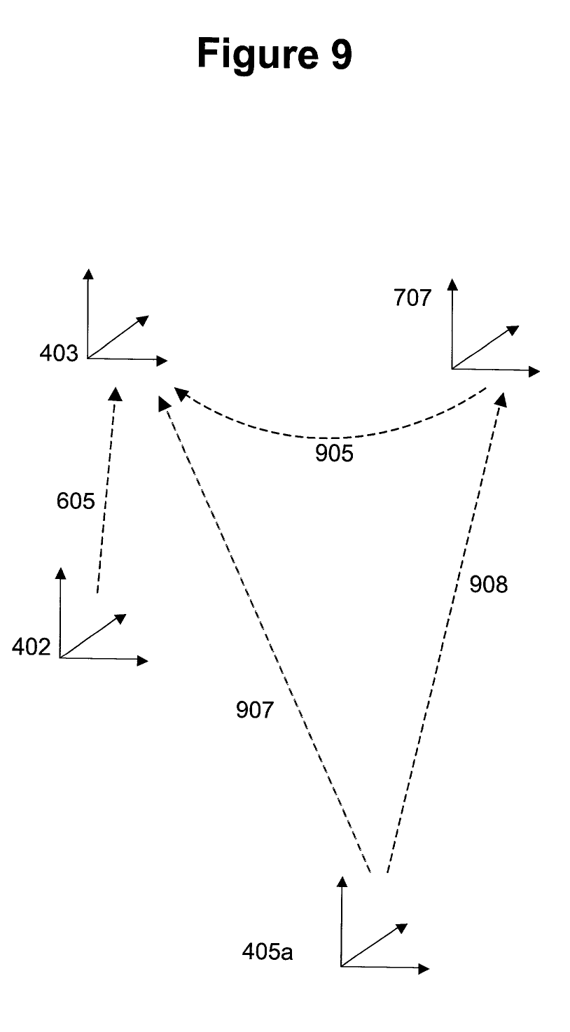

Referring to FIG. 9, preferred embodiments can include coordinate transformations in which registration transformation 905 from a coordinate frame 707 of a preoperative image to coordinate frame 403 of the patient 401b is calculated from patient 401b data, and morph transformation 908 from a coordinate frame 405a of an atlas 405b to a coordinate frame 707 of a preoperative image is calculated from image data, and morph transformation 907 from a coordinate frame 405a of an atlas 405b to coordinate frame 403 of the patient 401b is composed from the other two transformations, and relative pose 605 of the coordinate frame 402 of a tracked actual instrument 404d is provided from information provided by a tracking system. By means of these calculations the method provides morphs from an atlas to a patient and morphs from an atlas to a preoperative image, as well as registrations from a preoperative image to a patient.

In a first alternative embodiment for providing interventional guidance with preoperative images of a patient, the surface points in the patient coordinate frame are used as data to determine one or more rigid transformations between the coordinate frame or frames of the preoperative image or images and the patient coordinate frame. The patient data are also used to determine one or more morph transformations from the coordinate frame or frames 405a of the atlas 405b to the patient coordinate frame.

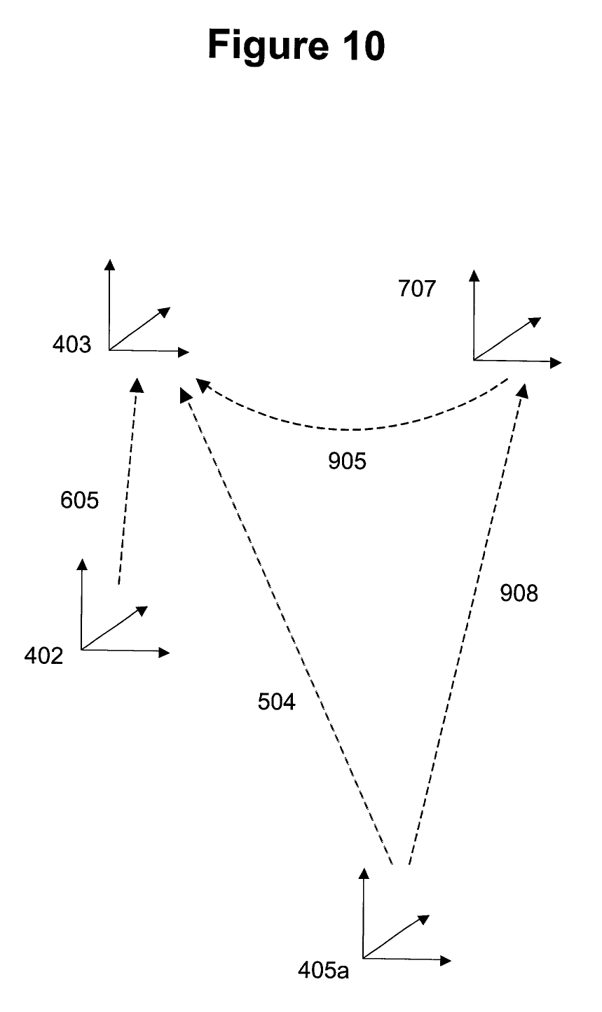

Referring to FIG. 10, the coordinate transformations of the first alternative embodiment are shown in which registration transformation 905 from a coordinate frame 707 of a preoperative image to coordinate frame 403 of the patient 401b is calculated from patient 401b data and morph transformation 908 from a coordinate frame 405a of an atlas 405b to a coordinate frame 707 of a preoperative image is calculated from image data and morph transformation 1007 from a coordinate frame 405a of an atlas 405b to coordinate frame 403 of the patient 401b is calculated from patient 401b data and relative pose 605 of the coordinate frame 402 of a tracked actual instrument 404d is provided from information provided by a tracking system. By means of these calculations the method provides morphs from an atlas to a patient and morphs from an atlas to a preoperative, as well as registrations from a preoperative image to a.

In a second alternative embodiment for providing interventional guidance with preoperative images of a patient, one or more morph transformations are calculated from the coordinate frame or frames 405a of the atlas 405b to the coordinate frame or frames 707 of the preoperative image or images. In the second alternative embodiment the surface points in the patient coordinate frame are used as data to determine one or more morph transformations from the coordinate frame or frames 405a of the atlas 405b to the patient coordinate frame.

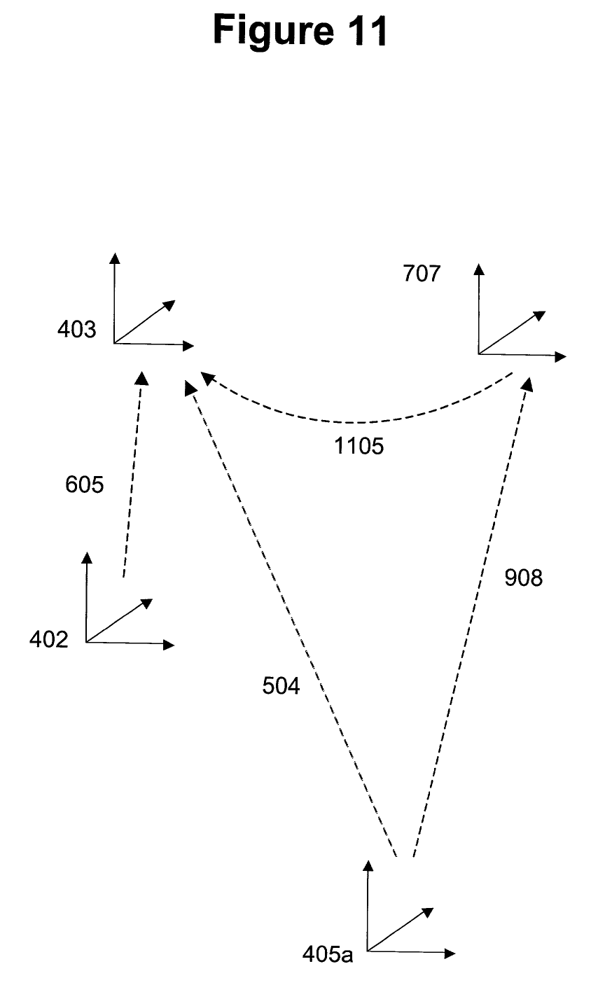

Referring to FIG. 11, the coordinate transformations of the second alternative embodiment are shown in which morph transformation 908 from a coordinate frame 405a of an atlas 405b to a coordinate frame 707 of a preoperative image is calculated from image data and morph transformation 1007 from a coordinate frame 405a of an atlas 405b to coordinate frame 403 of the patient 401b is calculated from patient 401b data and morph transformation 1105 from a coordinate frame 707 of a preoperative image to coordinate frame 403 of the patient 401b is calculated from the other two transformations and relative pose 605 of the coordinate frame 402 of a tracked actual instrument 404d is provided from information provided by a tracking system. By means of these calculations the method provides morphs from an atlas to a patient and morphs from an atlas to a preoperative image and morphs from a preoperative image to a patient.

In a third alternative embodiment for providing interventional guidance with preoperative images of a patient, the surface points in the patient coordinate frame are used to determine one or more rigid transformations between the coordinate frame or frames of the preoperative image or images and the patient coordinate frame. The surface points data are also used to determine one or more morph transformations from the coordinate frame or frames 405a of the atlas 405b to the patient coordinate frame. The resulting registration can be mathematically and numerically composed with a morph from an atlas coordinate frame to the patient coordinate frame and thus provide a morph from an atlas coordinate frame to a preoperative-image coordinate frame.

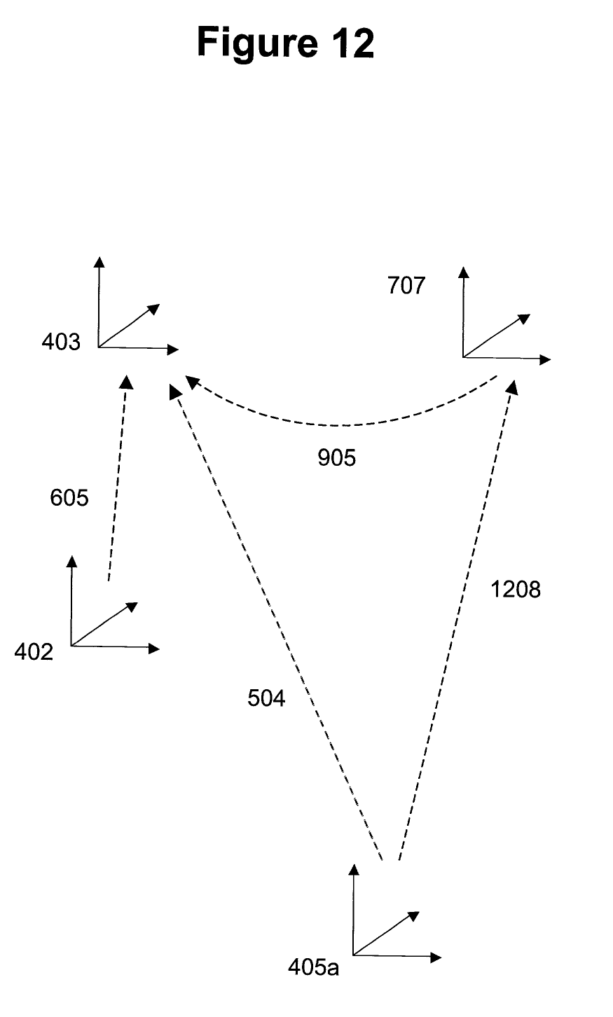

Referring to FIG. 12, the coordinate transformations of the third alternative embodiment are shown in which registration transformation 905 from a coordinate frame 707 of a preoperative image to coordinate frame 403 of the patient 401b is calculated from patient 401b data and morph transformation 1007 from a coordinate frame 405a of an atlas 405b to coordinate frame 403 of the patient 401b is calculated from patient 401b data and morph transformation 1208 from a coordinate frame 405a of an atlas 405b to a coordinate frame 707 of a preoperative image is calculated from the other two transformations and relative pose 605 of the coordinate frame 402 of a tracked actual instrument 404d is provided from information provided by a tracking system. By means of these calculations the method provides morphs from an atlas to a patient and morphs from an atlas to a preoperative image, as well as registrations from a preoperative image to a patient.

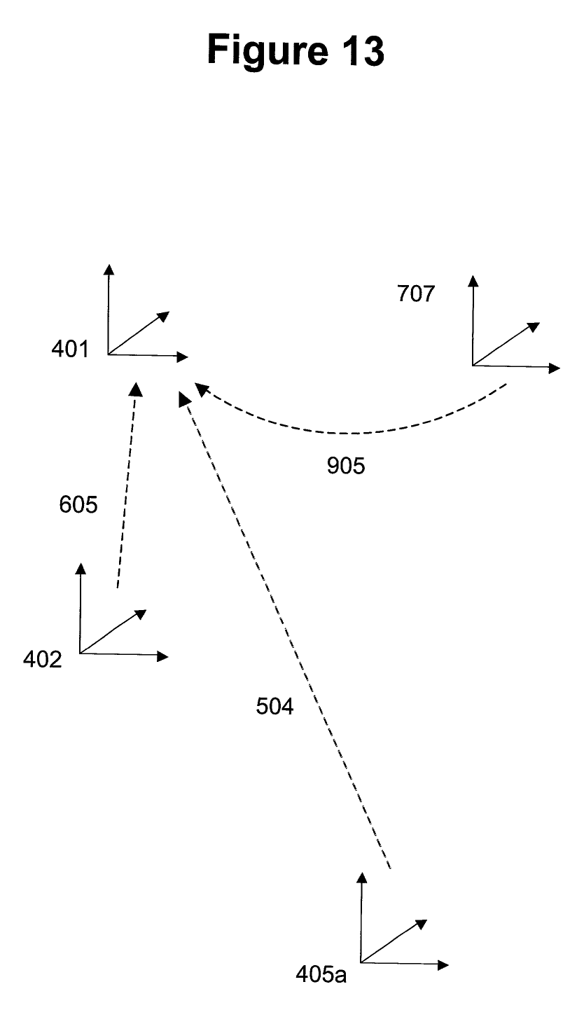

In a fourth alternative embodiment for providing interventional guidance with preoperative images of a patient, the surface points in the patient coordinate frame are used as data to determine one or more rigid transformations between the coordinate frame or frames of the preoperative image or images and the patient coordinate frame. The surface data are also used to determine one or more morph transformations from the coordinate frame or frames 405a of the atlas 405b to the patient coordinate frame. Referring to FIG. 13, the coordinate transformations of the fourth alternative embodiment are shown in which registration transformation 905 from a coordinate frame 707 of a preoperative image to coordinate frame 403 of the patient 401b is calculated from patient 401b data and morph transformation 1007 from a coordinate frame 405a of an atlas 405b to coordinate frame 403 of the patient 401b is calculated from patient 401b data and relative pose 605 of the coordinate frame 402 of a tracked actual instrument 404d is provided from information provided by a tracking system. By means of these calculations the method provides morphs from an atlas to a patient and registrations from a preoperative image to a patient.

In a fifth alternative embodiment for providing interventional guidance with preoperative images of a patient, one or more morph transformations are calculated from the coordinate frame or frames 405a of the atlas 405b to the coordinate frame or frames coordinate frame of the preoperative image or images. In the fifth alternative embodiment the surface points in the patient coordinate frame are used as data to determine one or more morph transformations from the coordinate frame or frames 405a of the atlas 405b to the patient coordinate frame.

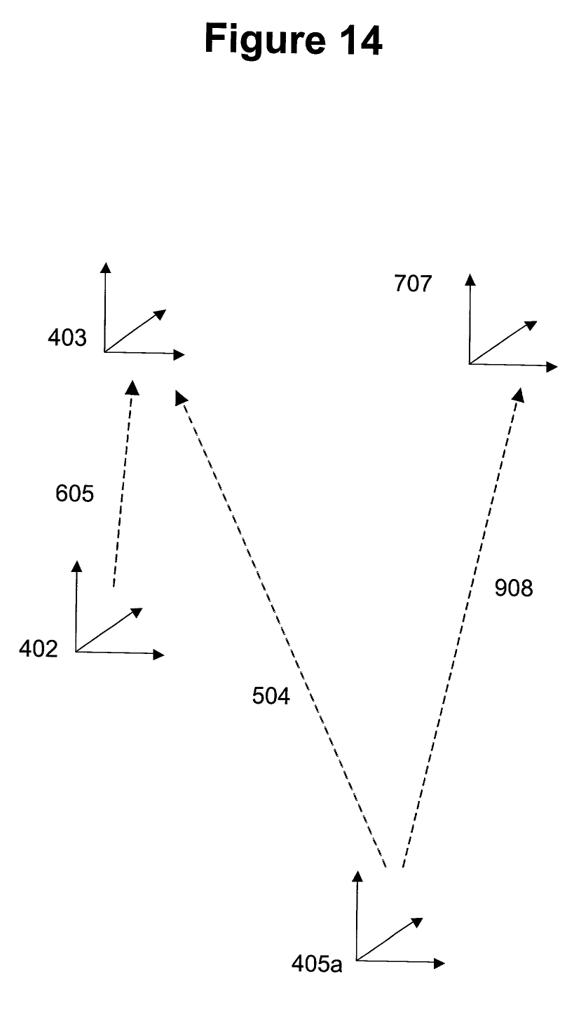

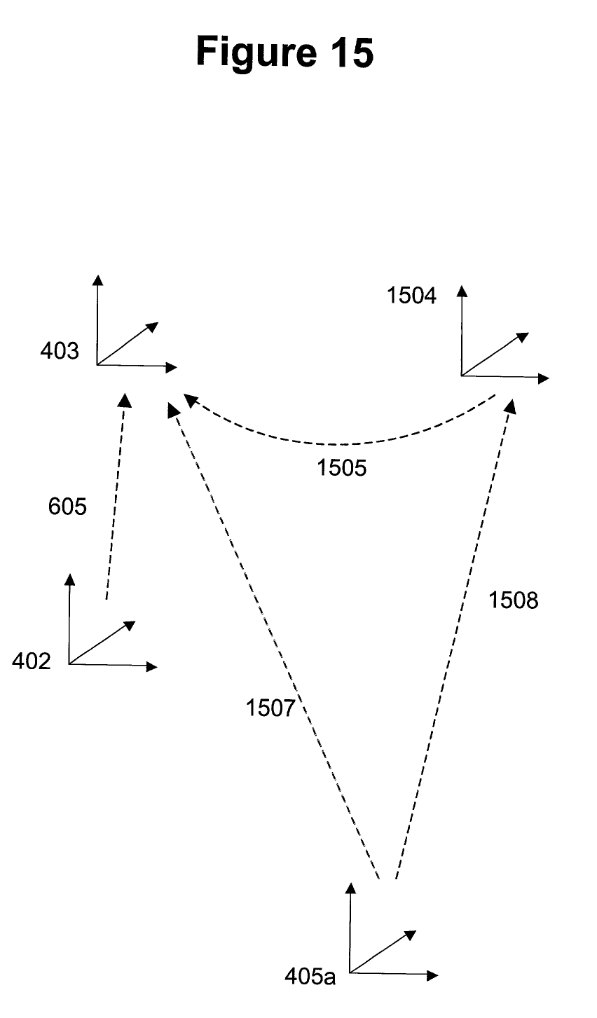

Referring to FIG. 14, the coordinate transformations of the fifth alternative embodiment are shown in which morph transformation 908 from a coordinate frame 405a of an atlas 405b to a coordinate frame 707 of a preoperative image is calculated from image data and morph transformation 1007 from a coordinate frame 405a of an atlas 405b to coordinate frame 403 of the patient 401b is calculated from patient 401b and relative pose 605 of the coordinate frame 402 of a tracked actual instrument 404d is provided from information provided by a tracking system. By means of these calculations the method provide morphs from an atlas to a patient and morphs from an atlas to a preoperative image.

The computer program 404a, or another computer program, can subsequently relate the location of the tracked actual instrument 404d or of another tracked actual instrument to the atlas 405b. In the preferred embodiment, the computer program 404a morphs images and other atlas data to the coordinate frame 403 of the patient, and displays these images and data to the physician with a computer representation of the tracked actual instrument 404d superimposed upon these images and data. By this method the physician can use the images and data to guide a tracked actual instrument 404d within the patient's body. In an alternative embodiment, the computer program 404a morphs the coordinate frame 403 of the patient 401b to the coordinate frame or frames 405a of the atlas 405b by means of the inverse of the morph transformation from the atlas coordinate frame or frames 405a to the patient coordinate frame 403, and displays atlas images and data to the physician with a computer representation of the deformed tracked actual instrument 404d superimposed upon these images and data.

Other data determined in the coordinate frame 403 of the patient 401b can be used to morph an atlas 405b to a patient, as described in the use of the preferred embodiment for guidance without images. A morphing transformation can be used to provide atlas data to an interventionalist, as described in the use of the preferred embodiment for guidance without images.

C. Morphing for Use in Guidance with Intraoperative Images

The use of morphing extends the intraoperative-image paradigm by providing atlas 405b information to the physician using the system. The atlas 405b information is provided by morphing an atlas 405b to the patient, or to an intraoperative image, or to both, for the purpose of intraoperative guidance. The morphing transformation from the atlas 405b to the patient 401b can be calculated using data collected from the patients anatomical surfaces, or data inferred from the patient's anatomy, or both forms of data, and data from the atlas 405b. The morphing transformation from the atlas 405b to an intraoperative image can be calculated using data derived from the intraoperative image and data from the atlas 405b. As for the use of preoperative images described in section B. above, the use of intraoperative images in conjunction with the atlas 405b can provide a better morph of the atlas to the patient 401b.

Morphing for guidance using an intraoperative image or images of a patient 401b can be explained by way of an example of how surgery for repair of a broken wrist might be performed. Suppose that an atlas 405b of the human right wrist has been developed by merging several detailed scans of volunteer subjects by both computed tomography imaging and magnetic resonance imaging, with annotated information in the atlas 405b provided by a practitioner skilled in the art of interpreting medical images. The annotations could include surface models of the bones of the wrist, the anatomical axes of the distal radius and ulna, the transverse axis of the distal radius, the bands of the radioulnar ligaments, the neutral lengths of the ligaments, and numerous other points and vectors and objects that describe clinically relevant features of the right wrist. During surgery for a fracture an intraoperative fluoroscopic image of the patient's right wrist could be acquired. The atlas images of the right wrist could be morphed to the intraoperative image of the patient's right wrist by many means, such as point-based methods that minimize a least-squares disparity function, gray-scale methods that maximize mutual information, or any other methods of determining a morphing transformation.

During a surgical intervention the fluoroscopic imaging device can be tracked by a tracking system. A relative-pose transformation can then be calculated between the intraoperative image and the points in a patient 401b coordinate frame. Using the morph transformation, a point in an atlas coordinate frame can be morphed into a patient 401b coordinate frame. The morphed point can be used in many ways, such as to determine the distance of the morphed point from one of the annotated axes, which provides to a physician an estimate of the location of an axis in a patient 401b where the axis might be difficult to estimate directly from the patient 401b. A computer program can then provide to the physician images derived from the intraoperative image, and images and annotations derived from the atlas 405b, to improve the physician's ability to plan and perform the surgical procedure.

In the preferred embodiment for providing interventional guidance with intraoperative images of a patient, a computer program communicates with a tracking system and can access one or more means of forming intraoperative images and an atlas 405b. The preferred embodiment utilizes a configuration similar to that previously described for FIG. 4; namely a first tracked device 401a with coordinate frame 403 is attached to a patient 401b and a tracking system 401c provides to a computer program 404a in computer 404b the pose 403a of the first tracked device 401a. In the preferred embodiment pose 403a is in the coordinate frame 403 of the first tracked device 401a. In an alternative embodiment this pose is provided in a second coordinate frame. A second tracked device 404c is attached to an actual instrument. In the preferred embodiment the pose 402a of the second tracked device 404c with coordinate frame 402 is provided to the computer program 404a in coordinate frame 403 of the first tracked device 401a. In an alternative embodiment the pose 402a of the tracked device 401a is provided to the computer program 404a in the second coordinate frame and the computer program 404a computes the relative pose 402a of the second tracked device 404c with respect to the coordinate frame 403 of the first tracked device 401a.

A third tracking device is attached to an actual instrument 404d so that the pose of a guidance point on the actual instrument 404d, in the coordinate frame 403 of the patient 401b, can be provided to the computer program 404a. In the preferred embodiment the pose of the third tracking device is provided to the computer program 404a as a pose in the coordinate frame 403 of the first tracked device 401a. In an alternative embodiment the pose of the third tracking device is provided to the computer program 404a as a pose in a second coordinate frame and the computer program 404a computes the relative pose of the third tracking device with respect to the coordinate frame 403 of the first tracked device 401a.

In the preferred embodiment for providing interventional guidance with intraoperative image or images, the intraoperative image or images are used to determine one or more morph transformations from the coordinate frame or frames 405a of the atlas 405b to the patient coordinate frame. In the preferred embodiment the intraoperative imaging system or systems may provide projection images or tomographic images. A morph transformation is calculated by means of one or more DRR's that are derived from the atlas 405b. In such a DRR for morphing to a projective intraoperative image, the DRR focal point corresponds to the real focal point of the projective intraoperative imaging device and the virtual surface of creation of a DRR corresponds to the real surface of creation of the projective intraoperative imaging device. In such a DRR for morphing to a tomographic intraoperative image, the DRR focal point or DRR projective direction corresponds to a direction parallel to the normal of a point on the surface of creation of the tomographic intraoperative imaging device. By measuring the disparity between data from one or more intraoperative images and data from one or more DRR's, and by minimizing this disparity, a morph can be calculated from the coordinate frame or frames of the atlas 405b to the patient 401b coordinate frame.

Referring to FIG. 15, the coordinate transformations of the preferred embodiment are shown, in which relative pose 1505 from a coordinate frame 1504 of an intraoperative image to coordinate frame 403 of the patient 401b is provided from information provided by a tracking system and morph transformation 1508 from a coordinate frame 405a of an atlas 405b to a coordinate frame 1504 of an intraoperative image is calculated from image data and morph transformation 1507 from a coordinate frame 405a of an atlas 405b to coordinate frame 403 of the patient 401b is composed from the other two transformations and relative pose 605 of the coordinate frame 402 of a tracked actual instrument 404d is provided from information provided by a tracking system. By means of these calculations the method provides morphs from an atlas to a patient and morphs from an atlas to an intraoperative image, as well as transformations from an intraoperative image to a patient.

In a first alternative embodiment for providing interventional guidance with an intraoperative image or images, a physician physically contacts the surfaces of anatomical regions of the patient 401b and the tracking system, or the computer program 404a, or both, determines the pose of the point on the actual instrument 404d in the coordinate frame of the first tracked device 401a, so that the coordinate frame of the first tracked device 401a acts as the coordinate frame 403 of the patient 401b. The points in the patient coordinate frame are used as data to determine a morph transformation from the coordinate frame or frames 405a of the atlas 405b to the coordinate frame 403 of the patient 401b. The pose of the tracking system can be mathematically and numerically composed with a morph from an atlas coordinate frame to the patient coordinate frame and thus provide a morph from an atlas coordinate frame to an intraoperative-image coordinate frame.

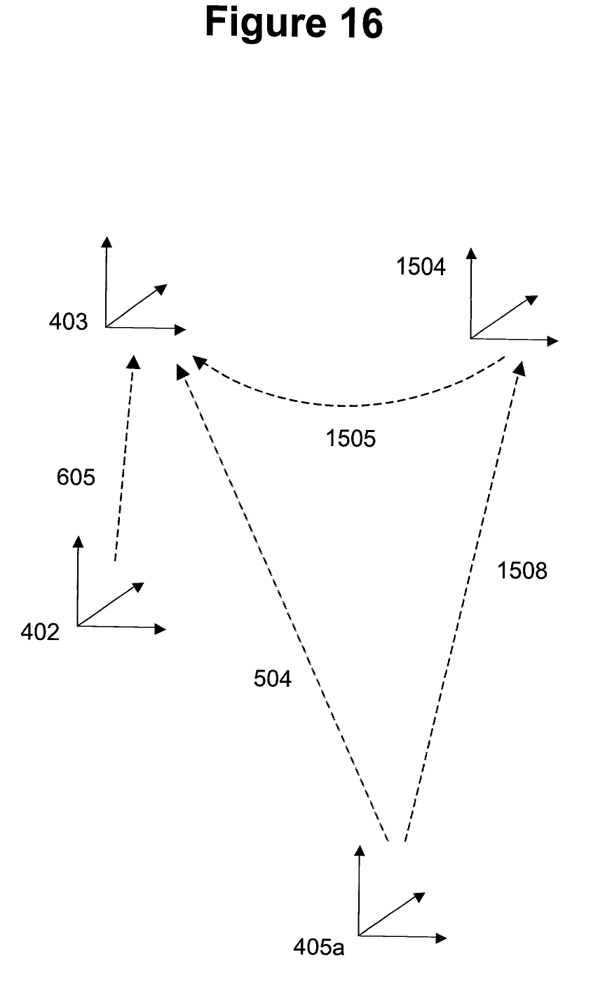

Referring to FIG. 16, the coordinate transformations of the first alternative embodiment are shown in which relative pose 1505 from a coordinate frame 1504 of an intraoperative image to coordinate frame 403 of the patient 401b is provided from information provided by a tracking system and morph transformation 1508 from a coordinate frame 405a of an atlas 405b to a coordinate frame 1504 of an intraoperative image is calculated from image data and morph transformation 1007 from a coordinate frame 405a of an atlas 405b to coordinate frame 403 of the patient 401b is calculated from patient 401b data and relative pose 605 of the coordinate frame 402 of a tracked actual instrument 404d is provided from information provided by a tracking system. By means of these calculations the method provides morphs from an atlas to a patient and morphs from an atlas to an intraoperative image, as well as transformations from an intraoperative image to a patient.

In a second alternative embodiment for providing interventional guidance with intraoperative image or images, a physician physically contacts the surfaces of anatomical regions of the patient 401b and the tracking system, or the computer program 404a, or both, determines the pose of the point on the actual instrument 404d in the coordinate frame of the first tracked device 401a, so that the coordinate frame of the first tracked device 401a acts as the coordinate frame 403 of the patient 401b. The points in the patient coordinate frame are used as data to determine a morph transformation from the coordinate frame or frames 405a of the atlas 405b to the coordinate frame 403 of the patient 401b.

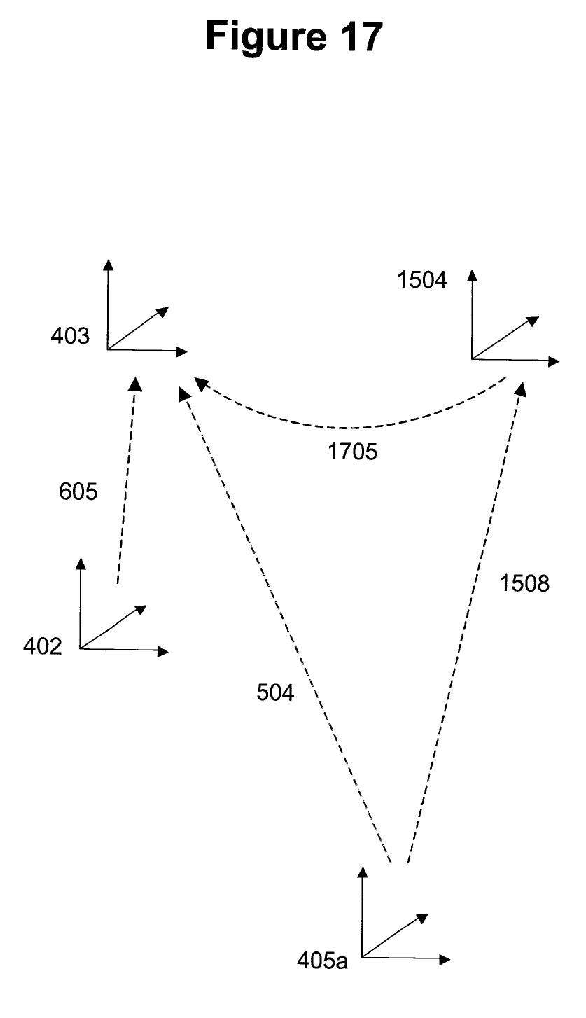

Referring to FIG. 17, the coordinate transformations of the second alternative embodiment are shown in which morph transformation 1508 from a coordinate frame 405a of an atlas 405b to a coordinate frame 1504 of an intraoperative image is calculated from image data and morph transformation 1007 from a coordinate frame 405a of an atlas 405b to coordinate frame 403 of the patient 401b is calculated from patient 401b data and morph transformation 1705 from a coordinate frame 707 of an intraoperative image to coordinate frame 403 of the patient 401b is calculated from the other two transformations and relative pose 605 of the coordinate frame 402 of a tracked actual instrument 404d is provided from information provided by a tracking system. By means of these calculations the method provides morphs from an atlas to a patient and morphs from an atlas to an intraoperative image and morphs from an intraoperative image to a patient

In a third alternative embodiment for providing interventional guidance with intraoperative image or images, a physician physically contacts the surfaces of anatomical regions of the patient 401b and the tracking system, or the computer program 404a, or both, determines the pose of the point on the actual instrument 404d in the coordinate frame of the first tracked device 401a, so that the coordinate frame of the first tracked device 401a acts as the coordinate frame 403 of the patient 401b. The points in the patient coordinate frame are used as data to determine a morph transformation from the coordinate frame or frames 405a of the atlas 405b to the coordinate frame 403 of the patient 401b.

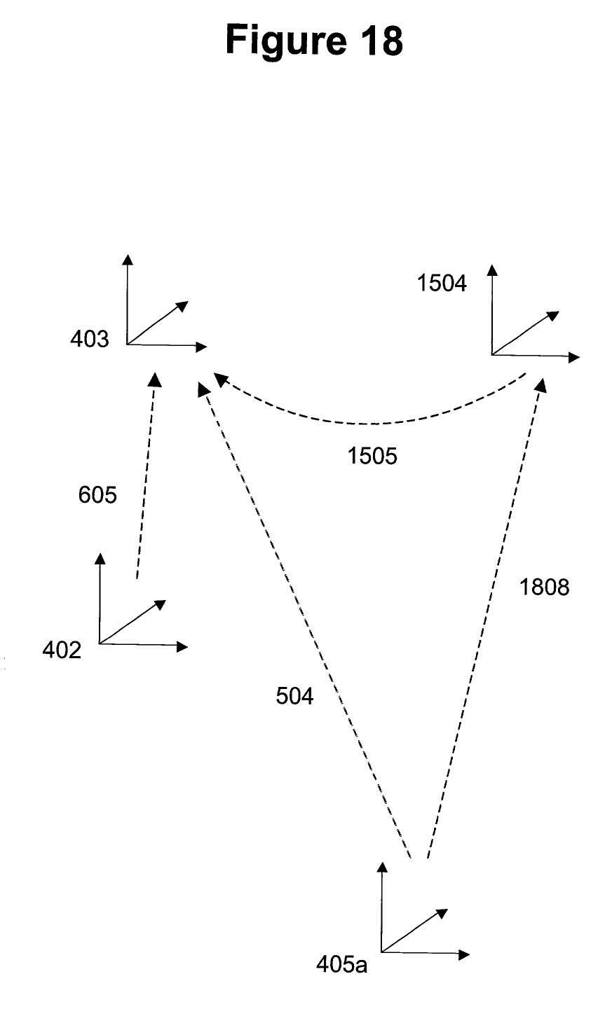

Referring to FIG. 18, the coordinate transformations of the third alternative embodiment are shown in which relative pose 1505 from a coordinate frame 1504 of an intraoperative image to coordinate frame 403 of the patient 401b is provided from information provided by a tracking system and morph transformation 1007 from a coordinate frame 405a of an atlas 405b to coordinate frame 403 of the patient 401b is calculated from patient 401b data and morph transformation 1808 from a coordinate frame 405a of an atlas 405b to a coordinate frame 1504 of an intraoperative image is calculated from the other two transformations and relative pose 605 of the coordinate frame 402 of a tracked actual instrument 404d is provided from information provided by a tracking system. By means of these calculations the method provides morphs from an atlas to a patient and morphs from an atlas to an intraoperative image, as well as transformations from an intraoperative image to a patient.

In a fourth alternative embodiment for providing interventional guidance with intraoperative image or images, the surface points in the patient coordinate frame are used as data to determine one or more morph transformations from the coordinate frame or frames 405a of the atlas 405b to the patient coordinate frame.

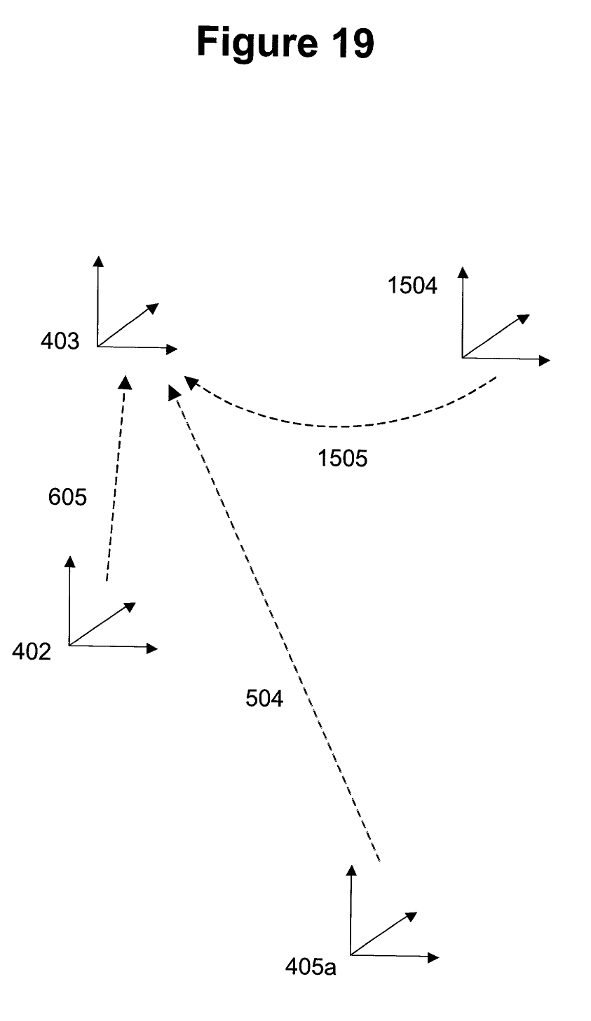

Referring to FIG. 19, the coordinate transformations of the fourth alternative embodiment are shown in which relative pose 1505 from a coordinate frame 1504 of an intraoperative image to coordinate frame 403 of the patient 401b is provided from information provided by a tracking system and morph transformation 1007 from a coordinate frame 405a of an atlas 405b to coordinate frame 403 of the patient 401b is calculated from patient 401b data and relative pose 605 of the coordinate frame 402 of a tracked actual instrument 404d is provided from information provided by a tracking system. By means of these calculations the method provides morphs from an atlas to a patient and transformations from an intraoperative image to a patient.

In a fifth alternative embodiment for providing interventional guidance with intraoperative image or images, one or more morph transformations are calculated from the coordinate frame or frames 405a of the atlas 405b to the coordinate frame or frames coordinate frame of the intraoperative image or images. In the fifth alternative embodiment the surface points in the patient coordinate frame are used as data to determine one or more morph transformations from the coordinate frame or frames 405a of the atlas 405b to the patient coordinate frame.

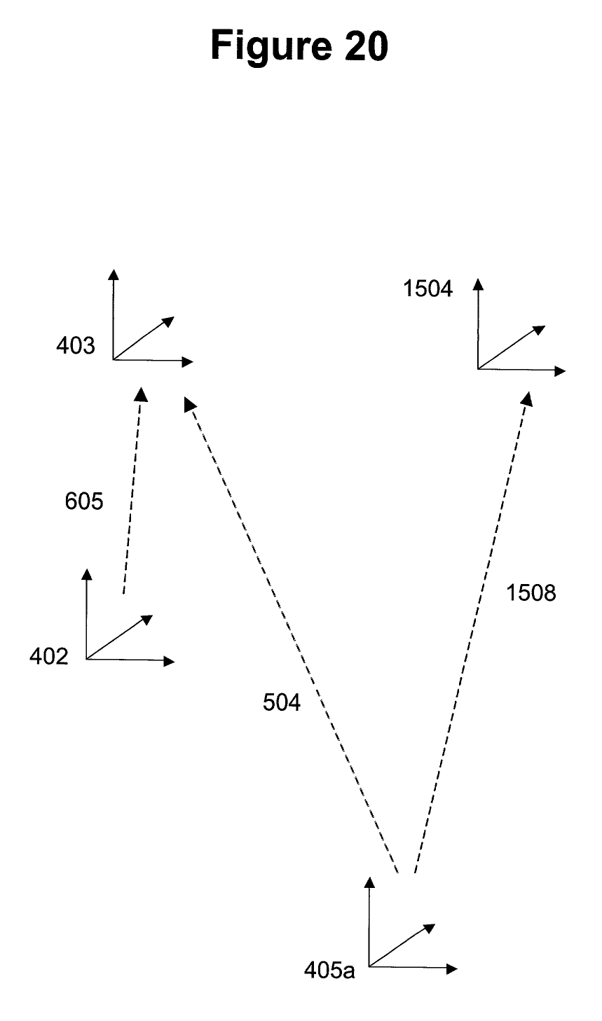

Referring to FIG. 20, the coordinate transformations of the fifth alternative embodiment are shown in which morph transformation 1508 from a coordinate frame 405a of an atlas 405b to a coordinate frame 1504 of an intraoperative image is calculated from image data and morph transformation 1007 from a coordinate frame 405a of an atlas 405b to coordinate frame 403 of the patient 401b is calculated from patient 401b data and relative pose 605 of the coordinate frame 402 of a tracked actual instrument 404d is provided from information provided by a tracking system. By means of these calculations the method provide morphs from an atlas o a patient and morphs from an atlas to an intraoperative image.

Other data determined in the coordinate frame 403 of the patient 401b can be used to morph an atlas 405b to a patient, as described in the use of the preferred embodiment for guidance without images. A morphing transformation can be used to provide atlas data to an interventionalist, as described in the use of the preferred embodiment for guidance without images.

D. Morphing for Use in Guidance with Multiple Image Types

The use of morphing extends the multiple-image-type paradigm by providing atlas 405b information to the physician using the system. The atlas 405b information is provided by morphing an atlas 405b to the patient, or to a preoperative image, or to an intraoperative image, or to all, for the purpose of intraoperative guidance. The morphing transformation from the atlas 405b to the patient 401b can be calculated using data collected from the patient's anatomical surfaces, or data inferred from the patient's anatomy, or both forms of data, and data from the atlas 405b. The morphing transformation from the atlas 405b to a preoperative image can be calculated using data derived from the preoperative image and data from the atlas 405b. The morphing transformation from the atlas 405b to an intraoperative image can be calculated using data derived from the intraoperative image and data from the atlas 405b. As for the separate use of preoperative images described in section B. above and intraoperative images described in section C. above, the use of a combination of preoperative images and intraoperative images in conjunction with the atlas 405b can provide a better morph of the atlas 405b to the patient 401b.

Morphing for guidance using multiple image types of a patient 401b can be explained by way of an example of how surgery for repair of a broken right hip might be performed. Suppose that an atlas 405b of the human left femur has been developed by merging several detailed scans of volunteer subjects by both computed tomography imaging and magnetic resonance imaging, with annotated information in the atlas 405b provided by a practitioner skilled in the art of interpreting medical images. The annotations could include surface models of the bone, the mechanical center of the distal femur, the mechanical center of the femoral head, the mechanical axis that joins the centers, the anatomical axis of the femur, the anatomical axis of the femoral neck, the anteversion and torsional angles of the femur, and numerous other points and vectors and objects that describe clinically relevant features of the human left femur. Prior to surgery a preoperative CT image of the patient's right and left hips could be acquired by CT scanning. The atlas images of the left femur could be morphed to the preoperative image of the unaffected left femur by many means, such as point-based methods that minimize a least-squares disparity function, volumetric methods that maximize mutual information, or any other methods of determining a morphing transformation. By performing a mirror-image transformation the atlas 405b and the CT image and related data can be reflected, to appear as and to represent right femurs. The morphing and reflection could provide much useful information, such as the predicted shape to which the fractured right femur should be restored and the desired femoral anteversion angle and the desired femoral torsion angle.

During surgery, an intraoperative fluoroscopic image of the patient's fractured right hip could be acquired while the fluoroscopic imaging device was tracked by a tracking system. A relative-pose transformation could then be calculated between the intraoperative image coordinate frame and the coordinate frame 403 of the patient 401b. The atlas images of the left femur could be morphed to the intraoperative image of the patient's right femur by many means, such as point-based methods that minimize a least-squares disparity function, gray-scale methods that maximize mutual information, or any other methods of determining a morphing transformation. Using the morph transformation, a point in an atlas coordinate frame can be morphed into a patient 401b coordinate frame. The morphed point can be used in many ways, such as to determine the distance of the morphed point from one of the annotated axes to provided to a physician an estimate of the location of an axis in a patient 401b where the axis might be difficult to estimate directly from the patient 401b. A computer program can then provide to the physician images derived from the preoperative and intraoperative images, and images and annotations derived from the atlas 405b, to improve the physician's ability to plan and perform the surgical procedure.

In the preferred embodiment for providing interventional guidance with preoperative images and intraoperative images of a patient, the system comprises a computer 404b and a tracking system 401c and one or more preoperative images and one or more means of forming intraoperative images and an atlas 405b. The preferred embodiment utilizes a configuration similar to that previously described with respect to FIG. 4 and the preferred embodiment for providing interventional guidance using intraoperative images of a patient, namely, a first tracked device 401a with coordinate frame 403 is attached to a patient 401b and a tracking system 401c provides to a computer program 404a in computer 404b the pose 403a of the first tracked device 401a. In the preferred embodiment pose 403a is in the coordinate frame 403 of the first tracked device 401a. In an alternative embodiment this pose is provided in a second coordinate frame. A second tracked device 404c is attached to an actual instrument. In the preferred embodiment the pose 402a of the second tracked device 404c with coordinate frame 402 is provided to the computer program 404a in coordinate frame 403 of the first tracked device 401a. In an alternative embodiment the pose 402a of the tracked device 401a is provided to the computer program 404a in the second coordinate frame and the computer program 404a computes the relative pose 402a of the second tracked device 404c with respect to the coordinate frame 403 of the first tracked device 401a.

A third tracking device is attached to an actual instrument 404d so that the pose of a guidance point on the actual instrument 404d, in the coordinate frame 403 of the patient 401b, can be provided to the computer program 404a. In the preferred embodiment the pose of the third tracking device is provided to the computer program 404a as a pose in the coordinate frame 403 of the first tracked device 401a. In an alternative embodiment the pose of the third tracking device is provided to the computer program 404a as a pose in a second coordinate frame F2 and the computer program 404a computes the relative pose of the third tracking device with respect to the coordinate frame 403 of the first tracked device 401a.

As a physician directly contacts surfaces of anatomical regions of the patient 401b and the tracking system, or the computer program 404a, or both, can determine the pose of the guidance point on the actual instrument 404d in the coordinate frame of the first tracked device 401a, so that the coordinate frame of the first tracked device 401a acts as the coordinate frame 403 of the patient 401b. Data can be collected from the patient 401b and registered to a preoperative image using methods described above, referring to FIG. 7 which shows a method that can be used for morphed guidance with an atlas image and to FIG. 8 which shows how the morph transformation and tracking of the actual instrument 404d pose can be used to morph an atlas image and superimpose a drawing of a virtual instrument on a morphed slice of the atlas image.

In the preferred embodiment for providing interventional guidance with preoperative images and intraoperative images of a patient, one or more morph transformations are calculated from the coordinate frame or frames 405a of the atlas 405b to the coordinate frame or frames of the preoperative image or images and one or more morph transformations are calculated from the coordinate frame or frames 405a of the atlas 405b to the coordinate frame or frames of the intraoperative image or images. A parameterization of a rigid transformation from the coordinate frame of a preoperative image to the coordinate frame 403 of the patient 401b is formulated. The parameters of the rigid transformation are calculated so as to minimize a disparity function between the transformed data in the preoperative image and the data in the patient coordinate frame. The resulting registration can be mathematically and numerically composed with a morph from an atlas coordinate frame to a preoperative-image coordinate frame and thus provide a morph from an atlas coordinate frame to the patient coordinate frame. In the preferred embodiment the intraoperative imaging system or systems may provide projection images or tomographic images.

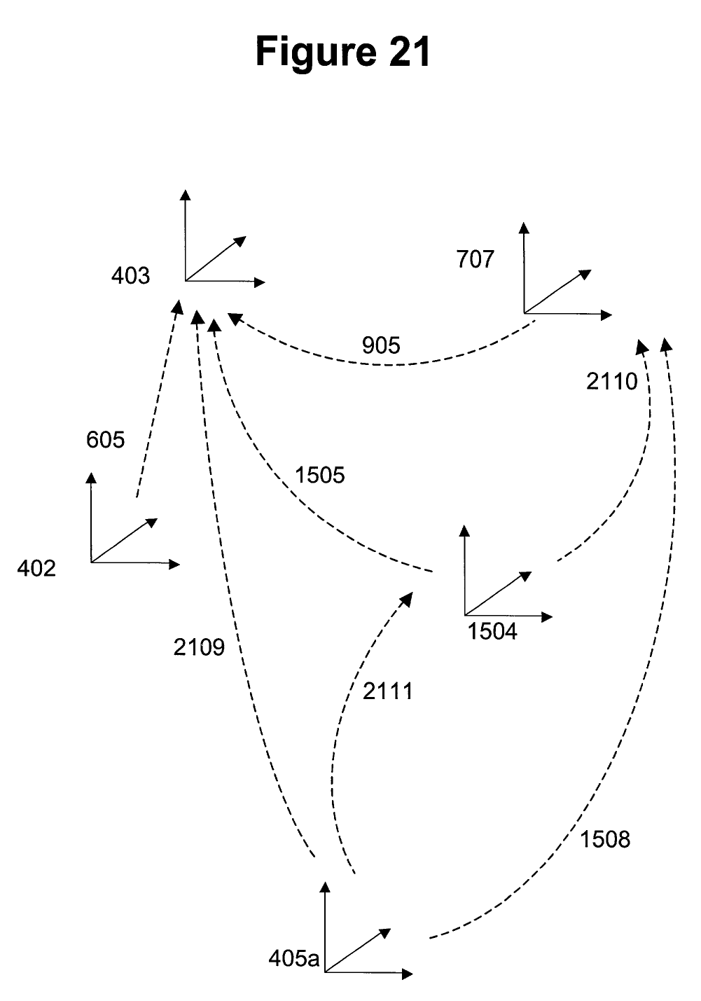

Referring to FIG. 21, the coordinate transformations of the preferred embodiment are shown in which there is a transformation between each pair of coordinate frames, the coordinate frames being the coordinate frame 403 of the patient 401b and a coordinate frame 707 of a preoperative image and a coordinate frame 405a of an atlas 405b and a coordinate frame 1504 of an intraoperative image. In the preferred embodiment, registration transformation 905 from a coordinate frame 707 of a preoperative image to coordinate frame 403 of the patient 401b is calculated from patient 401b data and morph transformation 1508 from a coordinate frame 405a of an atlas 405b to a coordinate frame 707 of a preoperative image is calculated from image data and morph transformation 2109 from a coordinate frame 405a of an atlas 405b to coordinate frame 403 of the patient 401b is composed from transformations 1508 and 905 and relative pose 405a of an intraoperative image is provided from information provided by a tracking system and morph transformation 2110 from a coordinate frame 1504 of an intraoperative image to a coordinate frame 707 of a preoperative image is composed from transformations 405a and 905 and morph transformation 2111 from a coordinate frame 405a of an atlas 405b to a coordinate frame 1504 of an intraoperative image is composed from transformations 1508, 905, and 405a and relative pose 605 of the coordinate frame 402 of a tracked actual instrument 404d is provided from information provided by a tracking system. By means of these calculations the method provide morphs and registrations between an atlas, a patient, a preoperative image, and an intraoperative image.

Alternative embodiments of a method for providing interventional guidance with multiple image types may be derived by combining preferred or alternative embodiments of a method for providing interventional guidance with preoperative images with preferred or alternative embodiments of a method for providing interventional guidance with intraoperative images. Such an alternative embodiment includes a morph from a coordinate frame of an atlas 405b to the coordinate frame 403 of the patient 401b and a rigid or morph transformation from a coordinate frame of an atlas 405b to the coordinate frame 403 of the patient 401b and a morph from a coordinate frame of an atlas 405b to the coordinate frame 403 of the patient 401b. In an alternative embodiment there may be other transformations between these three coordinate frames, whether derived from data or composed from other transformations.

Other data determined in the coordinate frame 403 of the patient 401b can be used to morph an atlas 405b to a patient, as described in the use of the preferred embodiment for guidance without images. A morphing transformation can be used to provide atlas data to an interventionalist, as described in the use of the preferred embodiment for guidance without images.

It will be understood by those skilled in the art that this description is made with reference to the preferred embodiment and that it is possible to make other embodiments employing the principles of the invention which fall within its spirit and scope as defined by the following claims.

I claim:

1. A method of obtaining interventional guidance for a patient, the method comprising the steps of:
a) Obtaining atlas data in an atlas coordinate frame from a computer-readable atlas of anatomical information;
b) Obtaining patient data in a patient coordinate frame that corresponds to obtained atlas data in an atlas coordinate frame, and
c) Morphing atlas data using a first morphing transformation between obtained patient data in a patient coordinate frame and corresponding obtained atlas data in an atlas coordinate frame.

2. The method of claim 1, further comprising the step of presenting morphed atlas data to an interventionalist.

3. The method of claim 1, wherein the step of obtaining patient data in a patient coordinate frame that correspond to atlas data in an atlas coordinate frame comprises the step of:
a) Collecting a plurality of points in a patient coordinate frame from the patient that correspond to points in an atlas coordinate frame from the atlas.

4. The method of claim 1, wherein the obtained patient data comprises a plurality of points from the patient anatomy in a patient coordinate frame, and the obtained atlas data comprises a plurality of points from the atlas in an atlas coordinate frame.

5. The method of claim 4, wherein the step of obtaining a plurality of points in a patient coordinate frame that correspond to points in an atlas coordinate frame from the atlas comprises the steps of:
a) Obtaining an image of the patient including a plurality of points in an image coordinate frame that correspond to points in an atlas coordinate frame from the atlas,
b) Collecting a plurality of points in a patient coordinate frame from the patient that correspond to points in an atlas coordinate frame from the atlas, and
c) Collecting a plurality of points in a patient coordinate frame from the patient that correspond to points in an image coordinate frame from the image,

6. The method of claim 5, further comprising the steps of:
a) Morphing the atlas to the image using a second morphing transformation between points in an image coordinate frame and corresponding points in an atlas coordinate frame, and
b) Registering the image to the patient using a registration transformation between a plurality of points in a patient coordinate frame and corresponding points in an image coordinate frame,
and wherein the step of morphing the atlas to the patient using a morphing transformation between points in a patient coordinate frame and corresponding points in an atlas coordinate frame comprises the step of:
c) Morphing the atlas to the patient using a third morphing transformation comprising the second morphing transformation and the registration transformation.

7. The method of claim 5, the method further comprising the steps of:
a) Morphing the atlas to the image using a second morphing transformation between an image coordinate frame and a corresponding atlas coordinate frame, and
b) Registering the image to the patient using a registration transformation between a plurality of patient coordinates and corresponding image coordinates.

8. The method of claim 5, further comprises the steps of:
a) Morphing the atlas to the image using a second morphing transformation between points in an image coordinate frame and corresponding points in an atlas coordinate frame, and
b) Morphing the atlas to the patient using a third morphing transformation between points in a patient coordinate frame and corresponding points in an atlas coordinate frame,
and wherein the step of morphing the atlas to the patient using a morphing transformation between points in a patient coordinate frame and corresponding points in an atlas coordinate frame comprises the step of:
c) Morphing the image to the patient using a fourth morphing transformation comprising the second morphing transformation and the third morphing transformation.

9. The method of claim 1, further comprising the steps of:
a) Obtaining a relative pose of an actual instrument relative to the patient,
b) Tracking the relative pose of the actual instrument; and
c) Updating the relative pose of a virtual instrument to be the same as the relative pose of the actual instrument.

10. The method of claim 9, further comprising the step of presenting the updated virtual instrument with the morphed atlas data to an interventionalist.

11. The method of claim 1, wherein the step of obtaining patient data in a patient coordinate frame that correspond to atlas data in an atlas coordinate frame comprises the step of:
a) Collecting patient data in a patient coordinate frame from the patient that corresponds to atlas data in an atlas coordinate frame from the atlas.

12. The method of claim 1, further comprising the steps of:
a) Obtaining an image of the patient including image data in an image coordinate frame that correspond to atlas data in an atlas coordinate frame from the atlas.

13. The method of claim 12, wherein the image is a preoperative image.

14. The method of claim 12, wherein the image is an intraoperative image.

15. The method of claim 12, further comprising the steps of:
a) Morphing atlas data using a second morphing transformation between obtained image data in an image coordinate frame and corresponding obtained atlas data in an atlas coordinate frame, and
b) Registering image data to patient data using a registration transformation between obtained patient data in a patient coordinate frame and corresponding obtained image data,
and wherein the step of morphing the atlas data using a morphing transformation between patient data in a patient coordinate frame and corresponding atlas data in an atlas coordinate frame comprises the step of:
c) Morphing atlas data using a third morphing transformation comprising the second morphing transformation and the registration transformation.

16. The method of claim 12, further comprising the steps of:
a) Morphing atlas data using a second morphing transformation between image data in an image coordinate frame and corresponding atlas data in an atlas coordinate frame, and
b) Registering image data and morphed atlas data from the second morphing transformation using a registration transformation between obtained patient data and corresponding obtained image data.

17. The method of claim 12, further comprising the steps of:
a) Morphing atlas data using a second morphing transformation between image data in an image coordinate frame and corresponding atlas data in an atlas coordinate frame, and
b) Morphing image data to the patient using a third morphing transformation comprising the first morphing transformation and the second morphing transformation.

18. The method of claim 12, further comprising the steps of:
a) Registering image data using a registration transformation between obtained patient data and corresponding obtained image data, and
b) Morphing atlas data using a second morphing transformation comprising the first morphing transformation and the registration transformation.

19. The method of claim 12, further comprising the step of:
a) Registering image data using a registration transformation between obtained patient data and corresponding obtained image data.

20. The method of claim 12, further comprising the step of:
a) Morphing atlas data using a second morphing transformation between image data in an image coordinate frame and corresponding atlas data in an atlas coordinate frame.

21. The method of claim 12, further comprising the steps of:
a) Obtaining a relative pose of an image from an image coordinate frame to a patient coordinate frame, and
b) Morphing atlas data using a morphing transformation between obtained atlas data and corresponding obtained image data,
and wherein the step of morphing the atlas data using a morphing transformation between patient data in a patient coordinate frame and corresponding atlas data in an atlas coordinate frame comprises the steps of:
c) Morphing atlas data using a morphing transformation comprising the first morphing transformation and the relative pose.

22. The method of claim 12, further comprising the steps of:
a) Obtaining a relative pose of an image from an image coordinate frame to a patient coordinate frame,
b) Morphing atlas data using a morphing transformation between obtained atlas data and corresponding obtained image data.

23. The method of claim 12, further comprising the steps of:
a) Morphing atlas data using a second morphing transformation between obtained atlas data and corresponding obtained image data, and
b) Morphing atlas data using a third morphing transformation comprising the first morphing transformation and the second morphing transformation.

24. The method of claim 12, further comprising the steps of:
a) Obtaining a relative pose of an image from an image coordinate frame to a patient coordinate frame, and
b) Morphing atlas data using a second morphing transformation comprising the first morphing transformation and the relative pose of the image coordinate frame to the patient coordinate frame.

25. The method of claim 12, further comprising the steps of:
a) Obtaining a relative pose of an image from an image coordinate frame to a patient coordinate frame.

26. The method of claim 12, further comprising the steps of:
a) Morphing atlas data using a morphing transformation between obtained atlas data and corresponding obtained image data.

27. The method of claim 1, further comprising the steps of:
a) Obtaining a preoperative image of the patient including image data in an image coordinate frame that correspond to atlas data in an atlas coordinate frame from the atlas,
b) Obtaining an intraoperative image of the patient including image data in an image coordinate frame that correspond to atlas data in an atlas coordinate frame from the atlas,
c) Obtaining a relative pose of an intraoperative image from an intraoperative image coordinate frame to a patient coordinate frame,
d) Registering preoperative image data using a registration transformation between obtained patient data and corresponding obtained preoperative image data,
e) Morphing atlas data using a second morphing transformation between obtained atlas data and corresponding obtained preoperative image data,
f) Morphing atlas data using a fourth morphing transformation comprising the registration transformation, the relative pose, and the second morphing transformation,
g) Morphing morphed atlas data morphed by the fourth morphing transformation and intraoperative image data using a fifth morphing transformation comprising the registration transformation and the relative pose,
and wherein the step of morphing the atlas data using a first morphing transformation between patient data in a patient coordinate frame and corresponding atlas data in an atlas coordinate frame comprises the step of:
h) Morphing atlas data using a third morphing transformation comprising the registration transformation and the second morphing transformation.

28. An apparatus for obtaining interventional guidance for a patient, the apparatus comprising:
a) Means for obtaining atlas data in an atlas coordinate frame from a computer-readable atlas of anatomical information;
b) Means for obtaining patient data in a patient coordinate frame that corresponds to obtained atlas data in an atlas coordinate frame, and
c) Means for morphing atlas data using a first morphing transformation between obtained patient data in a patient coordinate frame and corresponding obtained atlas data in an atlas coordinate frame.

29. The apparatus of claim 28, further comprising means for presenting the morphed atlas data to an interventionalist.

30. The apparatus of claim 28, further comprising:
a) Means for obtaining a relative pose of an actual instrument relative to the patient,
b) Means for tracking the relative pose of the actual instrument; and
c) Means for updating the relative pose of a virtual instrument to be the same as the relative pose of the actual instrument.

31. The apparatus of claim 30, further comprising means for presenting the updated virtual instrument with the morphed atlas data to an interventionalist.

32. An apparatus for obtaining interventional guidance for a patient, the apparatus comprising:
a) A tracking system for tracking actual objects;
b) A computer for receiving information on tracked objects,
c) A computer program on computer readable medium for operation on the computer, the computer program comprising instructions for:
Obtaining atlas data in an atlas coordinate frame from a computer-readable atlas of anatomical information;
Obtaining patient data in a patient coordinate frame that corresponds to obtained atlas data in an atlas coordinate frame, and
Morphing atlas data using a first morphing transformation between obtained patient data in a patient coordinate frame and corresponding obtained atlas data in an atlas coordinate frame.

33. A computer program for use in obtaining interventional guidance for a patient, the computer program for use in association with a tracking system for tracking actual objects and a computer for receiving information on tracked objects, the computer program on computer readable medium for operation on the computer, the computer program comprising instructions for:
Obtaining atlas data in an atlas coordinate frame from a computer-readable atlas of anatomical information;
Obtaining patient data in a patient coordinate frame that corresponds to obtained atlas data in an atlas coordinate frame, and
Morphing atlas data using a first morphing transformation between obtained patient data in a patient coordinate frame and corresponding obtained atlas data in an atlas coordinate frame.
